(19) United States
(12) Patent Application Publication
(10) Pub. No.: US 2024/0131508 A1
(43) Pub. Date: Apr. 25, 2024

(54) Diagnostics for Emerging Disease

(71) Applicant: Trellis Bioscience, Inc., Redwood City, CA (US)

(72) Inventors: Urs A. Ramel, Redwood City, CA (US); Joel Blatt, Redwood City, CA (US); Lawrence M. Kauvar, Redwood City, CA (US); Stote Ellsworth, Redwood City, CA (US); Ralph A. Tripp, Redwood City, CA (US); Leslie P. Jones, Redwood City, CA (US)

(73) Assignee: Trellis Bioscience, Inc., Redwood City, CA (US)

(21) Appl. No.: 18/383,777

(22) Filed: Oct. 24, 2023

Related U.S. Application Data
(63) Continuation of application No. PCT/US2022/026522, filed on Apr. 27, 2022.
(60) Provisional application No. 63/180,391, filed on Apr. 27, 2021.

(51) Int. Cl. B01L 3/00

(52) U.S. Cl. CPC B01L 3/502707; B01L 2200/0647; B01L 2300/0627; B01L 2300/18; B01L 2400/0683

(57) ABSTRACT

The present disclosure relates to enhancements in diagnostic assays for detection of analytes. The improved assays are suitable for management of infections and pandemics in humans and animal reservoirs, including but not limited to SARS-CoV-2 (CoV2), and for measurement of biomarkers of disease (both human and veterinary).

### CROSS-REFERENCE TO RELATED APPLICATIONS

This application is a continuation of, and claims priority benefit to, International Patent Application PCT/US2022/026522, filed Apr. 27, 2022, which claims priority benefit to U.S. provisional application 63/180,391, filed Apr. 27, 2021. The contents of each of these applications are expressly incorporated by reference herein in their entirety.

### TECHNICAL FIELD

The present disclosure relates to enhancements in diagnostic assays for detection of analytes. The improved assays are suitable for management of infections and pandemics in humans and animal reservoirs, including but not limited to SARS-CoV-2 (CoV2), and for measurement of biomarkers of disease (both human and veterinary).

### BACKGROUND

Numerous CoV2 diagnostic tests have been described, with the great majority comprising three classes: host immune response assays, also called serological or antibody tests; direct detection of viral proteins, also called antigen tests; and viral nucleic acid assays, also called molecular tests. While each class has advantages, molecular tests have been shown to provide the most reliable data on a subject's current viral load, which is important for prevalence assessment, for contact tracing, and for evaluation of efficacy of prophylactic or therapeutic interventions.

Molecular tests are typically based on PCR (polymerase chain reaction) and/or LAMP (loop-mediated isothermal amplification). The most widely used assay is based on PCR. LAMP was first described two decades ago, as recently reviewed {Notomi, T., Okayama, H., Masubuchi, H., Yonekawa, T., Watanabe, K., Amino, N. and Hase, T. (2000) Loop-mediated isothermal amplification of DNA. Nucleic Acids Res 28:E63; and U.S. Pat. Nos. 7,374,913; 7,851,186; 7,846,695 assigned to Eiken Chemical Co., Ltd}; {Wong Y P, Othman S, Lau Y L, Radu S, Chee HL Y. Loop-mediated isothermal amplification (LAMP): avers: the technique for detection of micro-organisms. J Appl Microbiol, 2018; 124(3):626-6431.

LAMP assays to detect CoV2, the causative agent of COVID-19, have been published by multiple investigators, including: {Ganguli A, Mostafa A, Berger J, Aydin M Y, Sun F, Ramirez S A S, Valera E, Cunningham B T, King W P, Bashir R. Rapid isothermal amplification and portable detection system for SARS-CoV-2. Proc Natl Acad Sci USA. 2020 Sep. 15; 117(37):22727-22735}, {Lalli M A, Langmade S J, Chen X, Fronick C C, Sawyer C S, Burcea L C, Wilkinson M N, Fulton R S, Heinz M, Buchser W J, Head R D, Mitra R D, Milbrandt J. Rapid and extraction-free detection of SARS-CoV-2 from saliva by colorimetric reverse-transcription loop-mediated isothermal amplification. Clin Chem. 2020 Oct. 24:hvaa267}, {Lee J Y H, Best N, McAuley J, Porter J L, Seemann T, Schultz M B, Sait M, Orlando N, Mercoulia K, Ballard S A, Druce J, Tran T, Catton M G, Pryor M J, Cui H L, Luttick A, McDonald S, Greenhalgh A, Kwong J C, Sherry N L, Graham M, Hoang T, Herisse M, Pidot S J, Williamson D A, Howden B P, Monk I R, Stinear T P. Validation of a single-step, single-tube reverse transcription loop-mediated isothermal amplification assay for rapid detection of SARS-CoV-2 RNA. J Med Microbiol. 2020 September; 69(9):1169-1178}; {Huang X, Tang G, Ismail N, Wang X. Developing RT-LAMP assays for rapid diagnosis of SARS-CoV-2 in saliva. EBioMedicine. 2022 January; 75:103736}; Heithoff D M, Barnes L 5th, Mahan S P, Fox G N, Arn K E, Ettinger S J, Bishop A M, Fitzgibbons L N, Fried J C, Low D A, Samuel C E, Mahan M J. Assessment of a Smartphone-Based Loop-Mediated Isothermal Amplification Assay for Detection of SARS-CoV-2 and Influenza Viruses. JAMA Netw Open. 2022 Jan. 4; 5(1):e2145669}.

The LAMP process begins with strand invasion by the forward outer and inner primers (F3, FIP) hybridizing to the target. A strand displacing DNA polymerase extends the primer and separates the target DNA duplex. The backward outer and inner primers (B3, BIP) then hybridize to the newly formed strand, enabling a further round of strand displacement replication. The reverse complementary sequences in the FIP and BIP lead to formation of self-hybridizing loops (dumbbell structure) which then becomes a seed for exponential amplification, with multiple sites for initiation of synthesis: from the 3′ ends of the open loops, from annealing sites for the inner primers, and from additional forward or backward loop primers (LF, FB). As amplification proceeds from these multiple sites, the products form long concatemers, each with more sites for initiation. The result is an exponential accumulation of double-stranded DNA (FIG. 21).

While other assays may be useful, point of care (POC) assays for CoV2 have particular utility as has been recently reviewed {Choi J R (2020) Development of Point-of-Care Biosensors for COVID-19. Front. Chem. 8:517}. A recent study concluded that time to results for CoV2, which is indicative of COVID-19 status, was significantly shorter in the POC group than in the control group (p<0.0001). In a related publication, the same investigators noted that POC diagnosis of influenza led to substantially shorter median time to antiviral administration: 1.0 hour vs 6.0 hours in the control group (p<0.004) {Brendish N J, Poole S, Naidu V V, Mansbridge C T, Norton N J, Wheeler H, Presland L, Kidd S, Cortes N J, Borca F, Phan H, Babbage G, Visseaux B, Ewings S, Clark T W. Clinical impact of molecular POC testing for suspected COVID-19 in hospital (COV-19POC): a prospective, interventional, non-randomised, controlled study. Lancet Respir Med. 2020 December; 8(12):1192-1200}; {Clark T W, Beard K R, Brendish N J, Malachira A K, Mills S, Chan C, Poole S, Ewings S, Cortes N, Nyimbili E, Presland L. Clinical impact of a routine, molecular, point-of-care, test-and-treat strategy for influenza in adults admitted to hospital (FluPOC): a multicentre, open-label, randomised controlled trial. Lancet Respir Med. 2020 Dec. 4:S2213-2600(20)30469-0}.

### BRIEF SUMMARY

In one embodiment, a microfluidic device includes a housing, a substrate, and a controller. The substrate is disposed within the housing and includes a sample well and a reaction well. The sample well has a sample port extending through the housing and is adapted to receive a sample and extract at least one analyte from the sample into a liquid assay sample. The reaction well is coupled to the sample well via a first microfluidic channel and a second microfluidic channel. The first microfluidic channel is coupled to the sample well at a proximal end, and the second microfluidic channel is coupled to the reaction well at a distal end. A distal end of the first microfluidic channel and a proximal end of the second microfluidic channel are isolated from each other via a fluid channel seal. The controller is adapted to connect the first and second microfluidic channels by breaking the fluid channel seal and to meter the liquid assay sample from the sample well into the reaction well for an assay.

In another embodiment, a method of performing an assay is provided. The method includes extracting an analyte from a sample received in a sample well via an extraction mixture, which may be in liquid form or dried form that is rehydrated by the sample. The first microfluidic channel is connected to a second microfluidic channel via a controller. The first microfluidic channel is coupled to the sample well at a proximal end, and the second microfluidic channel is coupled to a reaction well at a distal end. The controller breaks a fluid channel seal disposed between a distal end of the first microfluidic channel and a proximal end of the second microfluidic channel to connect the distal end of the first microfluidic channel and the proximal end of the second microfluidic channel. The method also meters the liquid assay sample from the sample well into the reaction well via the controller and assays the liquid assay sample in the reaction well.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows an embodiment of a microfluidic device with four reaction wells and one sample well, with a breakout of substrate and cover components.

FIG. 2 shows an embodiment of the microfluidic device depicting a sample carrier introduced into a sample port and sample well.

FIG. 3 shows an embodiment of the substrate front and rear views.

FIG. 4 shows an embodiment of the pistons with protrusions designed for frangible seal rupture.

FIG. 5A shows an embodiment of a reaction well formed by the mounting substrate or cartridge.

FIG. 5B shows an embodiment of a substrate including one or more sample well and one or more reaction well as well as microfluidic channels connecting the sample well and reaction well.

FIG. 6 shows an embodiment of the microfluidic device with cover removed and two controllers engaged to substrate.

FIG. 7A shows the rear surface of the microfluidic device depicted in FIG. 6.

FIG. 7B shows an embodiment of a knob controller adapted for use within the microfluidic device.

FIG. 7C shows an embodiment of the housing in which a plurality of ratchet interface surfaces are disposed on the inner surface of the housing around the knob openings.

FIG. 7D is a cut-away view showing an embodiment of a knob controller adapted for use within the microfluidic device disposed at a first, non-activated position.

FIG. 7E is a cut-away view showing an embodiment of a knob controller adapted for use within the microfluidic device disposed at a second, activated position.

FIG. 8 shows an embodiment of the printed circuit board.

FIG. 9A is an exploded view of an embodiment of a microfluidic device.

FIG. 9B is a perspective view of the housing bottom shown in FIG. 9A.

FIG. 10 shows a sample port with a peelable seal.

FIG. 11 shows a sample carrier being introduced into the sample port and sample well.

FIG. 12 shows a sample carrier positioned within the sample well for sample displacement.

FIG. 13 shows a dual controller cover and illuminated indicator lights following microfluidic device activation.

FIG. 14 shows a dual controller cover and illuminated end point indicator following assay completion.

FIG. 15 shows an embodiment of the microfluidic device with cover removed and two controllers engaged to substrate.

FIG. 16 shows the rear surface of the microfluidic device depicted in FIG. 15.

FIG. 17 shows the underside of exemplary controllers with pistons.

FIG. 18 shows a cutaway view of two controllers demonstrating the syringe piston ramps interaction with respective syringe pistons.

FIG. 19 shows an embodiment of colorimetric LAMP process.

FIGS. 20A and 2B show embodiments of a florescence LAMP process.

FIG. 21 is a schematic view of a LAMP assay.

FIG. 22 shows assay sensitivity results for CoV2 virus spiked into saliva samples.

FIG. 23 shows operation of the microfluidics using blue dye to track the liquid flow.

FIG. 24 shows a LAMP assay for CoV2 RNA using a colorimetric readout (cresol red dye changes color from pink to light yellow as pH drops during amplification of the DNA).

### DETAILED DESCRIPTION

Diagnostic tests for detection of an analyte(s) are provided herein. In one embodiment, the analyte(s) are nucleic acids. Enhancements in nucleic acid amplification are also described herein, for example applicable to LAMP. The assays are suitable for management of infections and pandemics in humans and animal reservoirs, including but not limited to SARS-CoV-2 (CoV2), and for measurement of markers of disease (both human and veterinary). In one embodiment, the diagnostic tests of the present invention can improve speed and accuracy and reduce reliance on skilled operators, which enables decentralized testing.

Biological samples or specimens to be assayed may be obtained by nasal swabs, tongue or cheek swabs, saliva, respiratory condensate, or other biological sources, such as urine or blood. Saliva is a common source for CoV2 detection: {Wyllie A L, Fournier J, Casanovas-Massana A, Campbell M, Tokuyama M, Vijayakumar P, Warren J L, Geng B, Muenker M C, Moore A J, Vogels C B F, Petrone M E, Ott I M, Lu P, Venkataraman A, Lu-Culligan A, Klein J, Earnest R, Simonov M, Datta R, Handoko R, Naushad N, Sewanan L R, Valdez J, White E B, Lapidus S, Kalinich C C, Jiang X, Kim D J, Kudo E, Linehan M, Mao T, Moriyama M, Oh J E, Park A, Silva J, Song E, Takahashi T, Taura M, Weizman O E, Wong P, Yang Y, Bermejo S, Odio C D, Omer S B, Dela Cruz C S, Farhadian S, Martinello R A, Iwasaki A, Grubaugh N D, Ko A I. Saliva or Nasopharyngeal Swab Specimens for Detection of SARS-CoV-2. N Engl J Med. 2020 Sep. 24; 383(13):1283-1286}; {Sakanashi D, Asai N, Nakamura A, Miyazaki N, Kawamoto Y, Ohno T, Yamada A, Koita I, Suematsu H, Hagihara M, Shiota A, Kurumiya A, Sakata M, Kato S, Muramatsu Y, Koizumi Y, Kishino T, Ohashi W, Yamagishi Y, Mikamo H. Comparative evaluation of nasopharyngeal swab and saliva specimens for the molecular detection of SARS-CoV-2 RNA in Japanese patients with COVID-19. J Infect Chemother. 2021 January; 27(1):126-129}; {Rao M, Rashid F A, Sabri FSAH, Jamil N N, Zain R, Hashim R, Amran F, Kok H T, Samad M A A, Ahmad N. Comparing nasopharyngeal swab and early morning saliva for the identification of SARS-CoV-2. Clin Infect Dis. 2020 Aug. 6:ciaa1156}.

In some embodiments, the diagnostic assays comprise an extraction mixture for extracting the analyte (e.g., nucleic acid or protein) from the sample or specimen. In one embodiment, for example, an extraction mixture can include denaturants or lytic agents, such as non-ionic detergents, that act to liberate the viral nucleic acid as well as divalent cation chelators, such as EDTA, that suppress degradation of the liberated nucleic acid by nucleases. Addition of sample to the extraction mixture not only provides the genetic substrate for amplification (in the case of PCR or LAMP based assays) but also may be used to inactivate the virus. In some embodiments, the extraction mixture can be contained in a sample well that receives the sample for analysis.

In some embodiments, the extraction mixture can include broad specificity protease such as Proteinase K, glycosidase and lipase enzymes to reduce sample matrix interference and to assist in lytic extraction of the nucleic acid from the virus. For certain assays, such as those using colorimetric detection based on acidification of the medium as amplification proceeds (e.g., colorimetric LAMP), it may be beneficial to control buffering capacity. In one embodiment, control of buffering capacity can be accomplished according to the methods described in U.S. Pat. No. 9,580,748 {Detection of an Amplification Reaction Product using pH-sensitive Dyes}, which is incorporated by reference.

In another embodiment, concentrated assay reagents can be lyophilized to improve stability, which is useful for allowing storage and shipping without refrigeration. The lyophilized reagents can readily dissolve when in contact with an aqueous solution. A desiccant can be provided in an assay packaging to prevent reagent deterioration from moisture absorption. In one embodiment, lyophilized beads of 0.5-10 mm diameter may be used to provide the enzymes and other reagents needed for the amplification assay (the reaction mixture) as well as the analyte-specific DNA primers. In some embodiments, the assay reagents are contained within a reaction well. Similarly, the agents used to lyse the virus in a liquid sample can also be provided in dried form.

Lyophilized beads can further include a fluorescent or colorimetric indicator for quantifying an analyte, for example amplified DNA. An embodiment of the beads includes sufficient divalent cations, such as Mg′, to offset chelators arising from the sample dissolved in the extraction mixture. In embodiments using a LAMP based assay, the components of the LAMP reaction mixture are known in the art and available commercially, such as the WarmStart Master Mix from New England Biolabs (Ipswich, MA), which includes Bst DNA polymerase. For tests based on detecting RNA, reverse transcriptase is also included. Primers specific for the analytes to be detected are provided [FIP/BIP 1.0 μM, F3/B3 0.2 μM, and LF/LB 0.4 μM]. Optionally, RNase H, an enzyme that cleaves RNA in an RNA/DNA substrate, may be included for assays based on reverse transcription of RNA into DNA for further LAMP amplification, as removal of the RNA facilitates the DNA polymerase activity.

In another embodiment, concurrently run assays enable differential diagnosis of infections, such as a differential diagnosis of infection by CoV2 versus seasonal influenza which has utility since the two infections have similar initial clinical symptoms but are treated differently. Utility has been established by the CDC (US Centers for Disease Control) which has issued an EUA (emergency use authorization) for a PCR assay that provides such a differential diagnosis {CDC catalog #Flu SC2-EUA Influenza SARS-CoV-2 Multiplex Assay, LB-122 Rev 01, 21 Sep. 2020}. Specific primers are disclosed for a LAMP based embodiment.

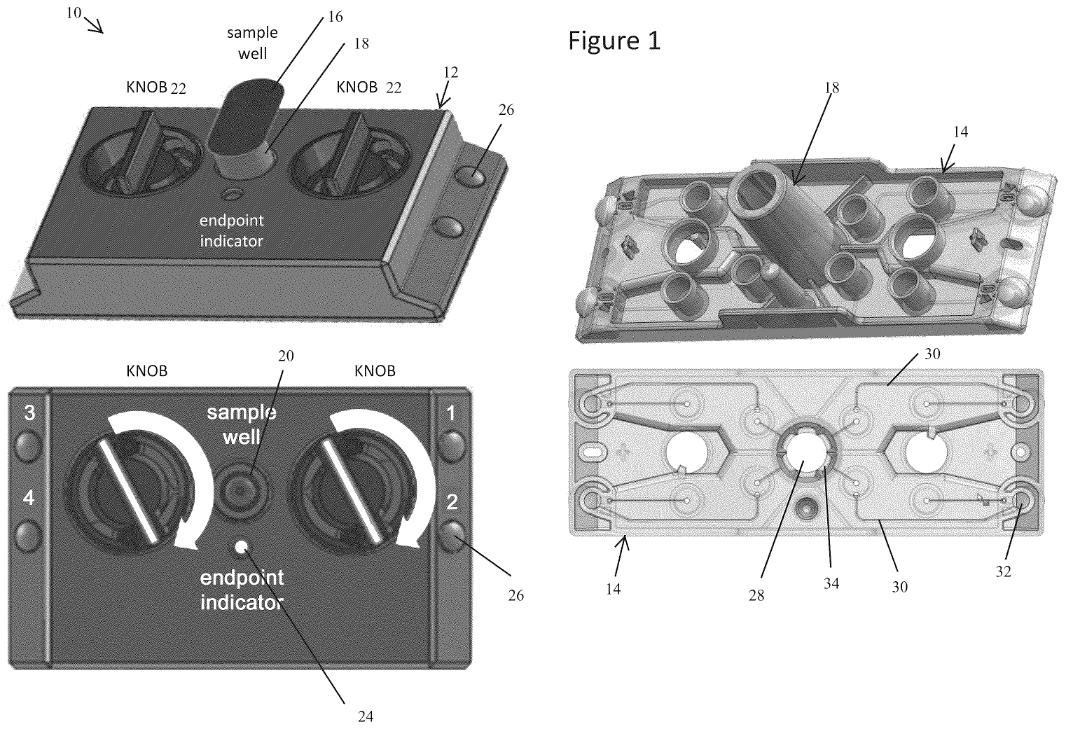

Lyophilized beads for LAMP assays are useful in several embodiments, including 96-well microplate assays. In an embodiment, the diagnostic assay is a point of care (POC) test performed on a microfluidic device. In one embodiment, the microfluidic device is portable. In another embodiment, the microfluidic device is a compact bench top device or handheld device that is easily carried. FIG. 1 shows views of an example microfluidic device 10 used for POC diagnostic assays. In this embodiment, the microfluidic device 10 includes a cover 12 and a substrate 14 (e.g., a fixed mounting substrate or cartridge) that is secured to or securable to the cover 12. FIG. 1 includes a perspective view (top left) and a top plan view (bottom left) of the microfluidic device 10. A removable and/or frangible seal 16 (e.g., a foil tab) covering the sample well is shown in the perspective view and removed in the top plan view. FIG. 1 also includes a perspective view of a substrate 14 (top right) and a bottom plan view (bottom right) of the substrate 14. In a single-use, disposable embodiment of the microfluidic device 10, the mounting substrate 14 can be fixed within the microfluidic device 10. In another reusable embodiment, the microfluidic device 10 may be reusable and configured to operate with disposable cartridges that may be used for each assay run in the microfluidic device 10. The perspective view shows a centrally disposed, generally cylindrical component 18 defining the sample port 20 that extends through the cover 12 to provide access to a sample well formed in the mounting substrate/cartridge via a layer (e.g., a foil or polymer layer) sealed to and forming the bottom of the mounting substrate/cartridge 14, shown below.

In various embodiments, the microfluidic device 10 includes a housing that differs depending on an application of the device. In a single use, disposable embodiment, for example, the housing may provide a structural enclosure surrounding a mounting substrate, a controller adapted to initiate and/or control an assay by performing one or more functions on components of the mounting substrate, and a printed circuit board (PCB) as described herein. In a reusable, portable embodiment, the housing may be adapted to accept cartridge(s) and provide components such as the controller and PCB for initiating and/or controlling an assay. Similarly, a benchtop instrument or other instrument typically fixed in a single location may be adapted to accept cartridges(s) and provide components such as a controller and PCB that assume some of the functionalities described for corresponding components described herein.

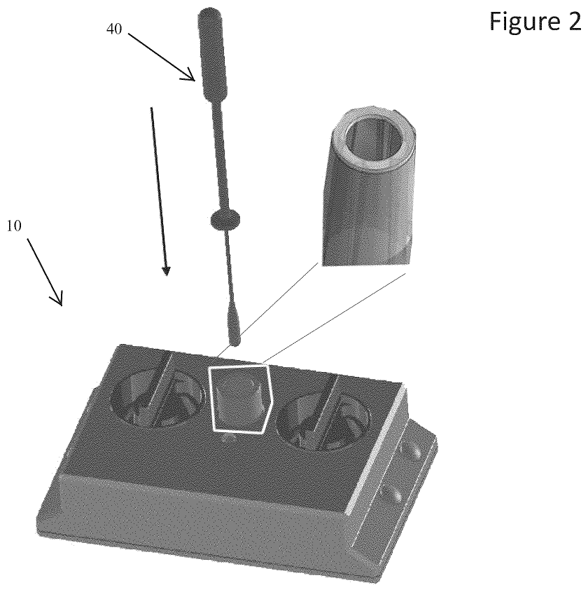

In one embodiment, the cover 12 includes at least one controller element 22 (e.g., a manual and/or electronic controller such as the two dials or knobs in the embodiment shown in FIG. 2) to initiate and/or control various microfluidic device functions. Other controller elements 22 may include a user operable input or actuator device, such as but not limited to a linear sliding controller, a push-button controller, a knob controller, or the like. The controller 22 may also include one or more pistons or other components adapted to connect microfluidic channels, such as by piercing a foil, polymer or other layer, and/or to meter a liquid sample into a reaction well as described herein. The cover 12 shown also includes a sample port 20 for receiving a sample/specimen carrier, such as a swab. In one embodiment, the sample port 20 is defined by a cylindrically shaped member 18 extending above the cover surface. In another embodiment, the sample port 20 is substantially co-planar with the cover surface. In another embodiment, the sample port 20 is connected to a sample well positioned on the mounting substrate or cartridge. In yet another embodiment, the cover 12 can also include one or more indicator elements 24 (e.g., LED lights), for example, in the embodiment illustrated in FIG. 1, a single end point indicator which alerts the operator when the assay is complete. The cover may also include one or more reaction well indicators 26, for example, to identify which specific assay steps are in progress. In the embodiment illustrated in FIG. 1, there are four reaction well indicators 26 labeled 1, 2, 3, and 4. In one embodiment, the indicators labeled 1, 2, 3, and 4 comprise plano-convex lenses to allow a user to view into the reaction wells, such as for a colorimetric assay, to allow the user to visually determine a result of the assay. FIG. 1 also shows an embodiment of a substrate 14 (e.g., a mounting substrate or cartridge), comprising the sample well 28, microfluidic channels 30, and reaction wells 32 adapted to perform one or more assays.

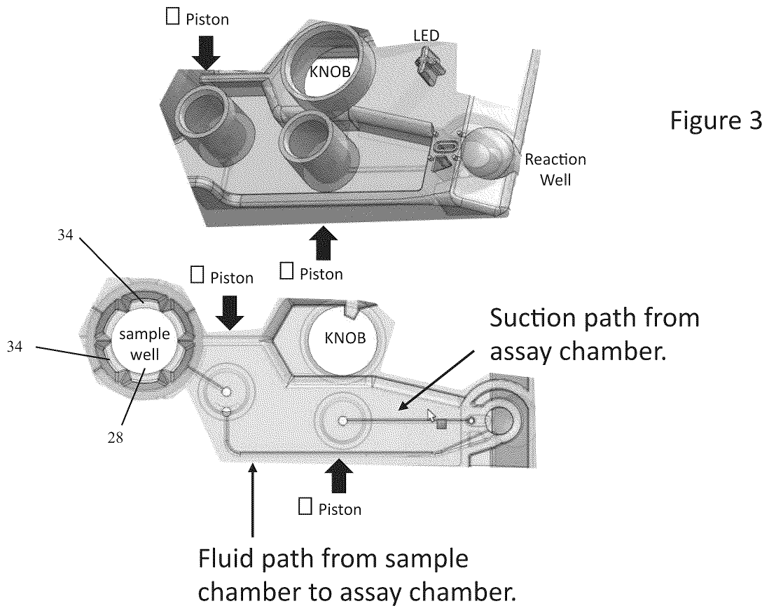

In one embodiment, a sample carrier 40 can be inserted directly into the microfluidic device 10 through a sample port as shown in FIG. 2. In some embodiments, the sample carrier 40 requires no intermediate processing prior to introduction into the sample port 20. The sample carrier 40 can be any suitable structure adapted or adaptable to transfer sample into the sample port 20 while minimizing sample loss, degradation, and/or contamination. For example, the sample carrier 40 can be a swab (e.g., as shown in FIG. 2) or a syringe, or the like. In one embodiment, a sample well 28 that includes an extraction mixture is positioned at the bottom of or beneath the sample port 20. In some embodiments, the sample port 20 includes a frangible seal 16 that covers the sample port 20 and protects the extraction mixture contained within the sample well 28. In another embodiment, the seal 16 covering the port 20 is removable, e.g., peelable. In another embodiment the frangible seal 16 is a foil membrane. In one embodiment, the sample carrier 40 contacts and ruptures the frangible seal 16 through applied pressure. Application of sufficient pressure by the sample carrier 40 may cause frangible seal 16 to rupture and sample carrier 40 to enter the sample well 28 and mix with the extraction mixture to displace the sample. In some embodiments, the sample carrier 40 introduces the sample into the extraction mixture without contacting the extraction mixture. Alternatively, the seal 16 covering the sample well can be peeled off to permit sample carrier insertion. Once introduced into the sample well, the sample carrier 40 and/or dislodged sample is mixed with the extraction mixture within the sample well 28. In one embodiment, at least one mixing member is provided (e.g., within the sample well 28) to aid in mixing. For example, a mixing member 34 can be a raised surface or rib that contacts the sample carrier and assists displacement of the sample into the extraction mixture. In one embodiment, at least one vertical rib 34 may be provided on the inside wall(s) of the sample well to aid in mixing by scraping sample off the swab. FIG. 3, for example, shows a breakout of a sample well with six vertical ribs 34 positioned on the interior wall(s) and adapted to aid in mixing by frictionally engaging the sample carrier. It should be noted that the mixing member 34 may be positioned on other suitable structures, for example, the interior walls of a cylindrically shaped sample port extending above the cover.

In one embodiment, the sample well 28 contains a volume (e.g., 1.5 mL) of an extraction mixture. The volume of the extraction mixture, for example, may represent a portion of the fluid volume of the sample well 28 (e.g., −50% of the well's capacity). After inserting the sample carrier 40, fluid displacement may occur raising the fluid level to a greater portion of the sample well volume (e.g., −75%). In some embodiments, the sample well 28 may include one or more fluid containment elements. For example, in one embodiment, the top of the sample well's opening can be smaller (e.g., −10% smaller) than the diameter of the sample well, which inhibits ejection of fluid from the well during mechanical mixing [see, e.g., FIG. 2].

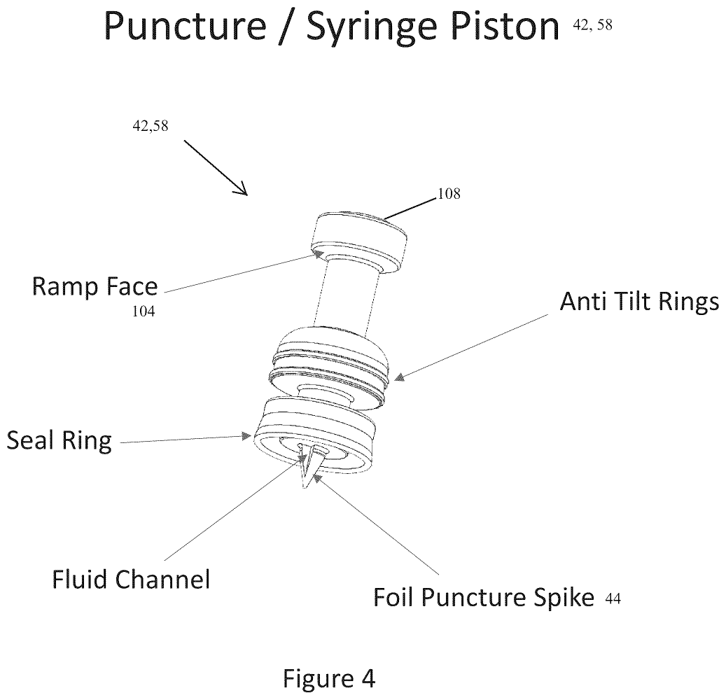

In one embodiment, the substrate may contain at least one reaction well(s) 32 and a microfluidic channel(s) 30 allowing the reaction well(s) 32 and sample well 28 to be connected. In another embodiment, the microfluidic channel(s) 30 connects the sample well 28 to a series of reaction wells 32 arranged in sequential order as determined by the particular assay. In the embodiment shown in FIGS. 1 and 2, a knob can be turned (e.g., from 10-180 degrees, such as approximately 150 degrees (12:00 to 5:00 position on a clock face)) to initiate one or more actions. In one embodiment, the following actions are initiated in such manner: (a) a piston 42 is depressed downwards wherein the bottom surface of the piston 42 has a protrusion 44, such as a sharp point or edge as shown in FIG. 4 that pierces a foil membrane releasing the sample solution into a microfluidics pathway 30 leading to a reaction well 32; (b) after a short delay, such as approximately 1-5 seconds, a second piston 48 is elevated, creating negative pressure (suction) to draw a consistent amount of the fluid into the reaction well 32; and (c) an electrical switch is activated, turning on a microprocessor that controls intermittent heating of pads disposed beneath each reaction well. One embodiment of a pad is made of copper for efficient heat transfer to the reaction well, with intermittent heating used to maintain the temperature at a consistent value, e.g. based on thermistor measurement(s) at those sites.

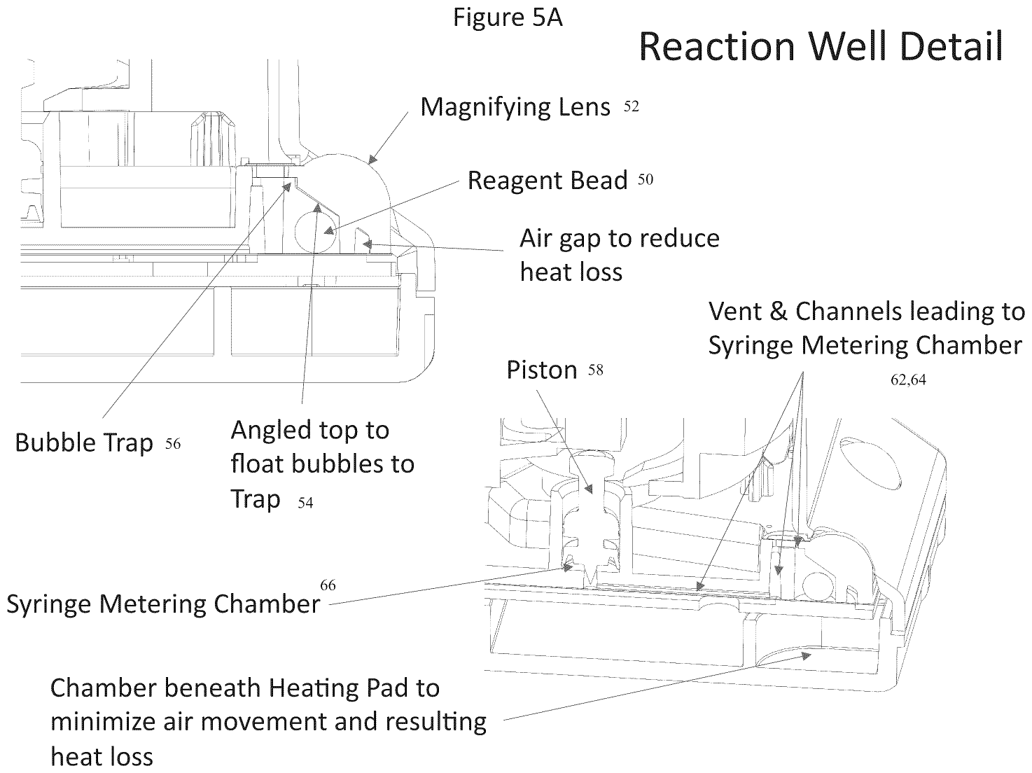

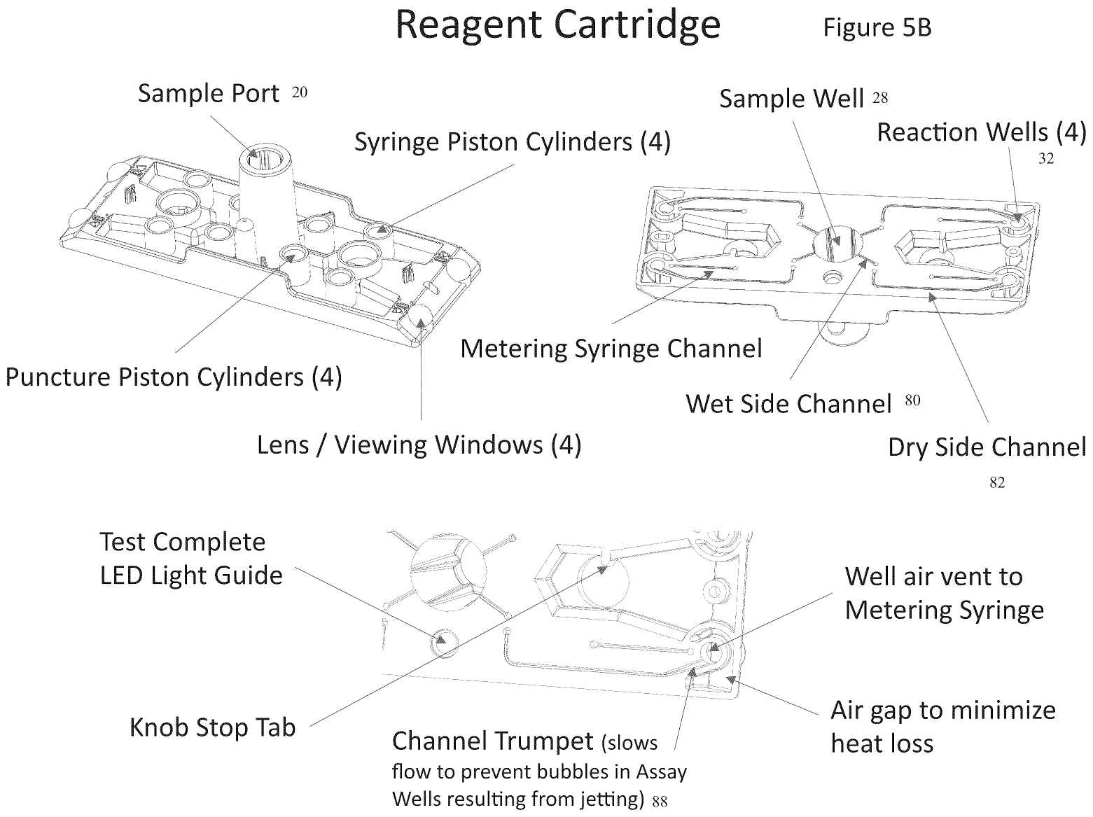

FIG. 5A shows an embodiment of a reaction well that is formed by the mounting substrate or cartridge. In this embodiment, the reaction well houses a reagent bead 50 (e.g., a lyophilized bead) supporting a reaction mixture used in an assay within the reaction chamber 32. The reaction well 32 in this embodiment includes a viewing lens 52 (e.g., a magnifying lens) positioned to allow a visual inspection of the reaction well, such as for a colorimetric assay. As shown in FIG. 5A, the magnifying lens 52 has a sloped flat inner surface 54 forming a portion of the sample well perimeter. The sample well 32 can also include an opening disposed above the sloped inner surface of the lens that provides a bubble trap 56 disposed above the viewing region of the lens. This opening 56 allows bubbles to float upward above the viewing region of the lens 52 so that bubbles formed within the reaction well 32 do not obstruct the view of the reaction well 32 via the lens 52.

FIG. 5A also shows a venting and metering system 60 adapted to control the amount of sample drawn into the reaction well 32 for the assay. In this embodiment, the reaction well 32 includes a vent 62 and one or more vent channels 64 disposed between the reaction well 32 and a metering chamber 66. A piston 58 is disposed within the metering channel and is adapted to be retracted within the metering channel by a controller 22 (e.g., by a knob surface). As described in further detail below, the knob or other controller 22 is adapted to retract the metering piston 58 within the chamber. The piston 58 is closely fit within the chamber, and the retraction of the piston 58 within the chamber provides suction to pull air from the reaction well 32 into the vent channel(s) 64 via the one or more vent channels and the vent of the reaction well and thereby to create negative pressure to draw fluid into the reaction well 32. By controlling the movement of the piston 58, a precise, metered amount of sample liquid can be drawn into the reaction chamber 32 from one or more microfluidic channels 30 disposed between the reaction well 28 and the sample well 32.

In some embodiments, the pistons 42, 58 in steps (a) and (b) above travel in opposite directions. In one embodiment, the controller(s) 22 (e.g., dial or knob) contains a ramp that contacts the pistons as the controller is turned. The controller 22 may include ratcheting teeth that mate with the inside surface of the cover to restrict turning to one direction (e.g., clockwise). In another embodiment, a hard stop can be provided to prevent over-filling the reaction well. As shown in FIG. 5B, for example, a knob stop tab extends into an opening through which a controller knob is inserted. The knob stop tab 70 provides a surface adapted to engage a corresponding surface of the knob controller to prevent the controller knob 22 from rotating past a predetermined position.

In one embodiment, each piston forms a hermetic seal with a corresponding barrel. A flared bell bottom of the piston and a slightly raised collar at the top of the barrel can be provided [see, e.g., FIG. 4]. The barrel, in one embodiment, comprises polypropylene, although this is only an example material that may be used. In one embodiment, fabricating the pistons from one or more different plastic(s), such as polyamide (nylon) or polyoxymethylene (Delrin®), can provide sufficient flexibility in the contact surfaces to form a seal between the piston and corresponding barrel. In another example, a thin layer of silicone grease can be applied to the barrel's interior surface or to an exterior surface of the piston before inserting the piston into the corresponding barrel as an alternative method of providing the desired seal (e.g., hermetic seal).

In one embodiment, the pair of pistons is duplicated (totaling 4 pistons) to provide a parallel path for a control or an independent assay. The same or a different controller may be used to control both pairs of pistons together or independently. As a further option, the quartet of pistons can be replicated to enable two additional assays, controlled by a second knob [see, e.g., FIG. 1]. This feature can be used to enable a differential diagnosis from a sample, such as a differential diagnosis of CoV2 from influenza, including a positive control.

In one embodiment, the reaction well 28 contains one or more lyophilized beads. The beads, in some embodiments, may have a diameter in the range of between about 0.5 to 10 mm. In another embodiment, a single bead has a diameter of about 0.5 mm. Each bead can contain reagents required for the assay in general (the reaction mixture) as well as for the specific assay being performed. The volume and concentrations used in the reaction well may be established using small test tubes, such as in a 96-well microplate. In one embodiment, for example, the reaction well volume is 25 microliters. Lyophilized beads may contain analyte specific reaction agents, including for example, analyte specific DNA primers. In other words, in this embodiment, all other reagents required for a reaction are fixed and not analyte specific. This feature facilitates reprogramming of the assay allowing a prompt response to emerging or mutating pathogens. In some embodiments, reaction agents may be validated prior to use. For example, in nucleic acid-based assays, probes can be validated, such as by using a 96-well microplate format assay, before manufacturing the new point of care assay.

FIG. 5B shows an embodiment of a mounting substrate or cartridge including one sample well 28 and four reaction wells 32 as well as wet side and dry side channels adapted to allow a liquid sample to flow from the sample well 28 to reaction wells 32, respectively. However, this is merely one possible configuration. Any number of sample wells and corresponding reaction wells may be provided. For each respective reaction well 32, a wet side channel 80 is disposed in communication with the sample well 28. The wet side channel 80 terminates at an opening 84 disposed within a puncture piston cylinder 86. A corresponding opening disposed within the puncture piston cylinder provides an origin of a corresponding dry side channel 82 that is in communication with the respective reaction well 32. A frangible seal, such as a heat-sealed foil layer, is disposed covering the pair of openings to prevent liquid from the wet side from entering the dry side thus maintaining the reaction well 32 in a dry condition. When the puncture piston 42 is driven through the frangible seal (action (a) above), the sample well 28 and reaction well 32 are communicatively coupled so that a sample liquid may flow (e.g., be metered) into the reaction well 32 for an assay. In one example, the dry side microfluidic channel 80 may comprise a flared-out trumpet shape 88 as the microfluidic channel 82 feeds into a reaction well 32 [see, e.g., FIG. 5B]. This feature eliminates overly rapid entry of sample fluid into the reaction well which may cause foaming (bubbles). By slowing down the sample flow into the reaction wells 32, the chamber fills reliably from the bottom up and remains free of bubbles that could interfere with the readout. Uniform dissolution of the lyophilized bead is also facilitated by this feature.

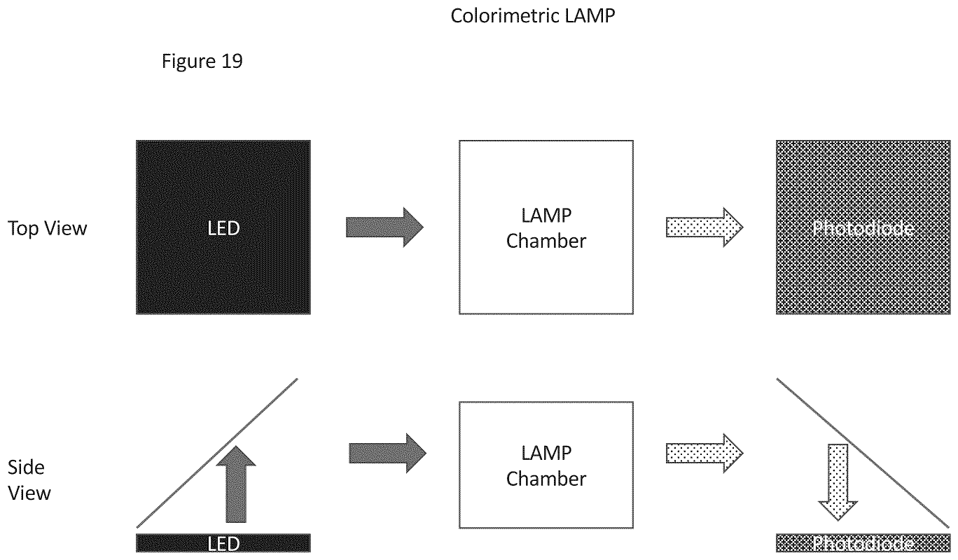

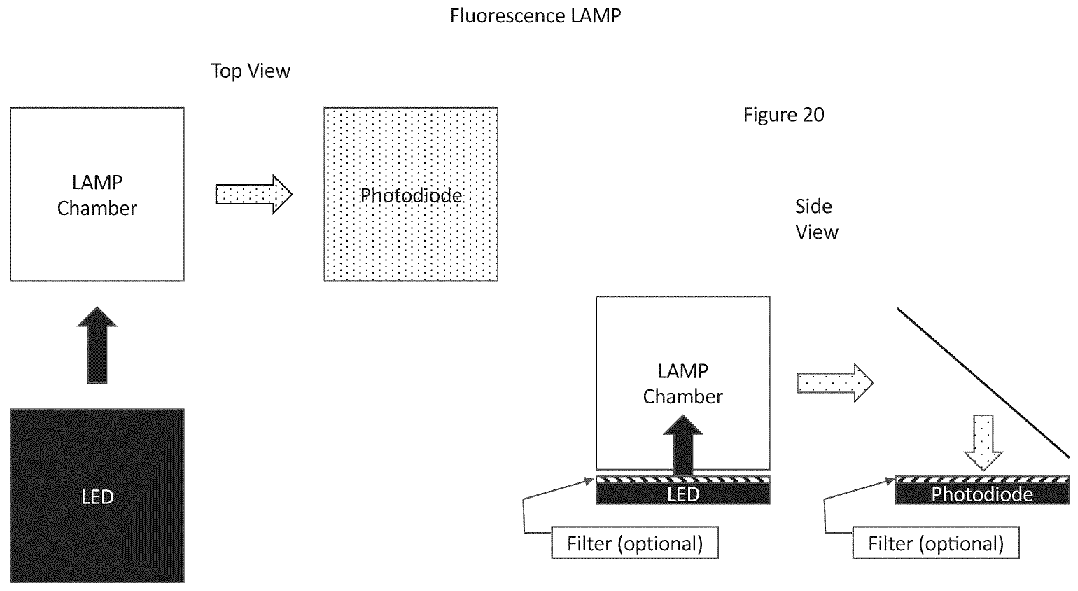

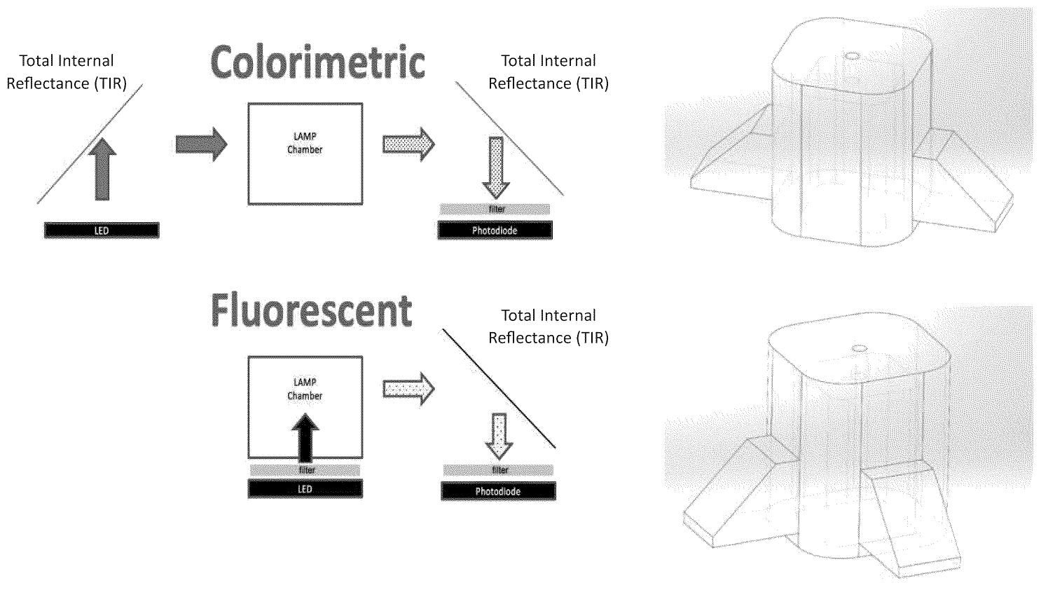

In one embodiment, an assay readout can be accomplished using either colorimetric or fluorescent dyes. Illumination can be by an LED (light emitting diode) of an appropriate wavelength. Optionally, filters may also be used to enhance discrimination between the illumination and the assay signal. For visual readout, the reaction well can optionally be covered at a predetermined angle, for example, from 5-60 degrees by a magnification lens. In other embodiments, the predetermined angle is 45 degrees, the lens can be plano-convex, and the reaction well magnification can be 2-3× [see, e.g., FIG. 5A]. In another embodiment, the illuminating light can be directed into the reaction well by total internal reflectance elements positioned within the reaction well or the like and the transmitted or emitted fluorescent light directed by similar means to a photodiode for detection. A difference between colorimetric and fluorescent detection is the orientation of the detection light path relative to the incident light path, with the former being in the same plane and the latter being perpendicular. Measuring transmitted light also enables measuring turbidity arising from precipitation of magnesium complexed with pyrophosphate released during DNA polymerization. If a photodiode is used, rather than visual readout, then a threshold level of light is established that leads to turning on an assay endpoint readout (yes/no) indicator light. Alternatively, the rate of change of the assay signal may be measured (kinetic assay) and that additional information used to determine the assay result. FIG. 19 shows a block diagram of an example colorimetric LAMP system, and FIGS. 20A and 20B show block diagrams of example Fluorescence LAMP systems.

In one embodiment, activation of the electrical switch turns on a microprocessor that provides several useful functions. For example, reaction well LEDs can be turned on in this manner. Also, power to reaction well heating elements (e.g., heating pad(s) under each reaction well) can be provided intermittently under the control of the microprocessor, based on a temperature-sensing thermistor or other temperature-sensing device, in order to maintain reaction well temperature in a predetermined range (e.g., a range of 60° to 70° Centigrade, such as an example range of 63-67° C. or 64-66° C.). Another microprocessor-controlled function turns on an additional LED at a preset time to indicate that the results are ready to be read [see, e.g., FIG. 1]. The same circuit may turn off power to the heating elements. That is, the test can be conducted as an endpoint assay, which is particularly suitable for a point-of-care device used by operators without specialized training. Sensitivity can be adjusted, such as by changing the concentration of reagents in the dried bead or by changing the run time of the assay.

In one embodiment, the heating pad is a square piece of copper (e.g., 3×3 mm and 0.5 mm high). The copper pad can be heated, such as by a set of small resistors. The height of the copper pads can provide an air gap from the bulk of the device reducing heating other than at the reaction well. An air insulator around the reaction well further reduces the power consumption [see, e.g., FIGS. 5A and 5B]. FIGS. 5A and 5B show an embodiment in which one or more chambers are disposed around the heating pad and/or the reaction well. The chamber(s) are adapted to restrict air movement and reduce heat loss at the reaction well and reduce thermal heating remote from the reaction well. With intermittent heating, and the insulation features, a single AA battery may be used to provide sufficient power for the entire assay in four reaction wells, which is particularly convenient for decentralized operation of the assay. In one embodiment, the battery is easily removed from the device for disposal separately from the rest of the device.

In yet another embodiment, diagnostic assays can be formatted to enable both serological and molecular assays in a single device. A competitive immunoassay format is suitable for this purpose: a DNA-labelled detector antibody (or aptamer, or other antibody-like binding moiety) of moderate affinity for a viral antigen is precluded from binding to immobilized analyte (or analyte mimic) by presence of higher affinity or more abundant antibodies in the sample; for example, the immobilized analyte may be on beads present in the sample well that are too large to enter the microfluidic channel. The DNA labelled probe is detected via a LAMP amplification assay. In this manner, the same assay format can be used for both serological and molecular assays. Similarly, direct detection of a viral antigen can be accomplished by preparing a DNA-labelled version of the antigen and capturing it on agarose beads using an antibody. If the viral antigen is present in the patient sample, it will displace the labelled tracer from the bead-bound antibody allowing it to enter the microfluidics pathway. The resulting positive signal in the reaction well indicates presence of the antigen in the patient sample.

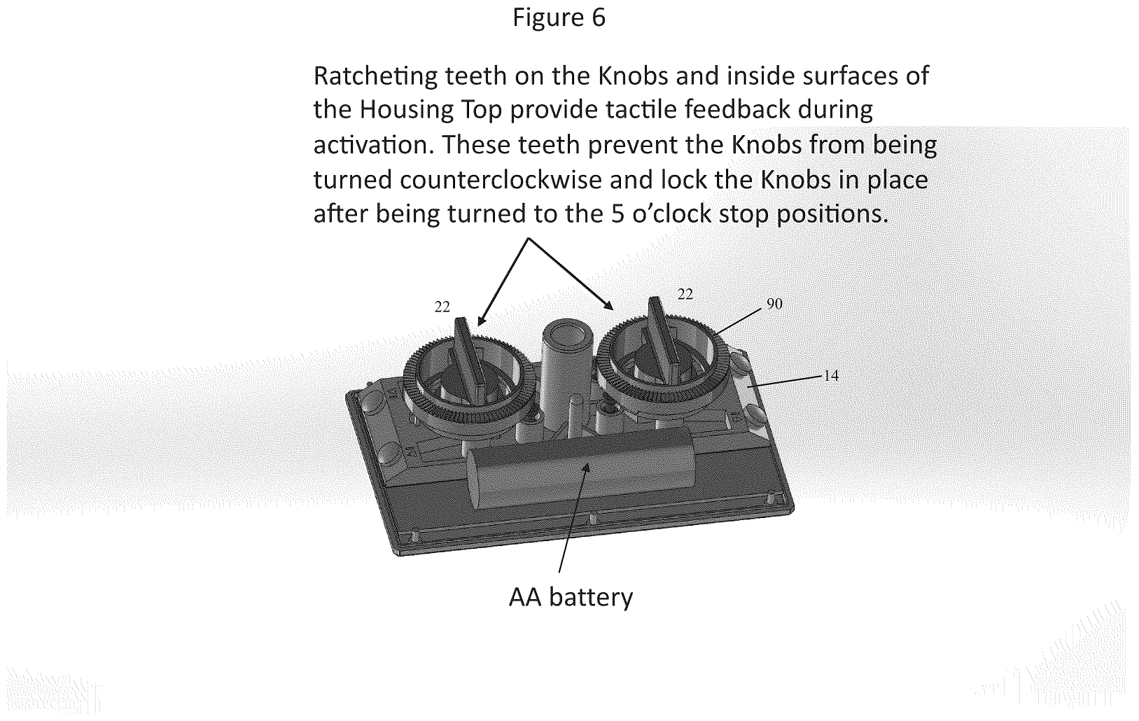

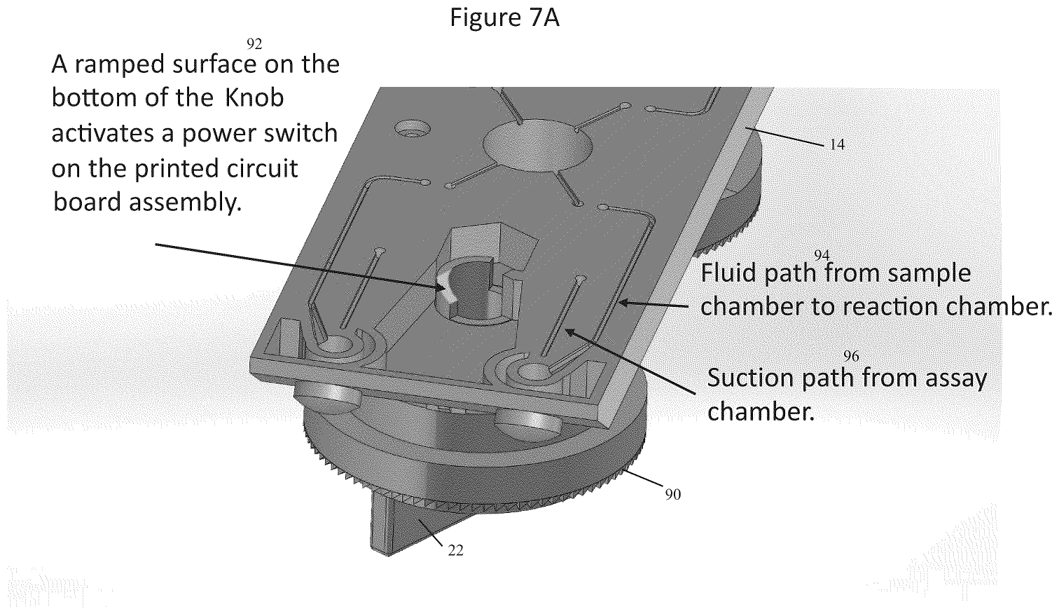

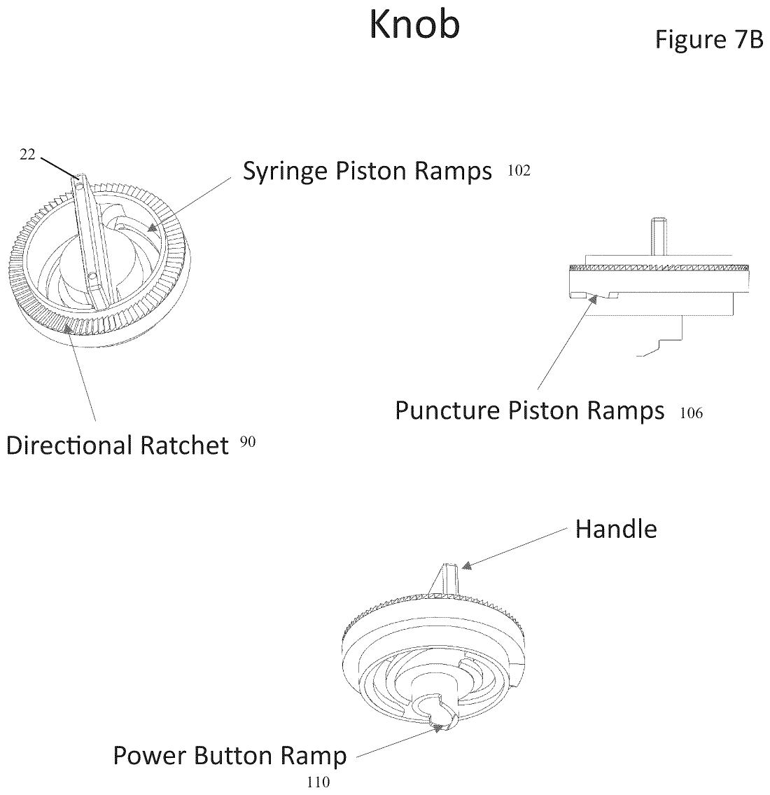

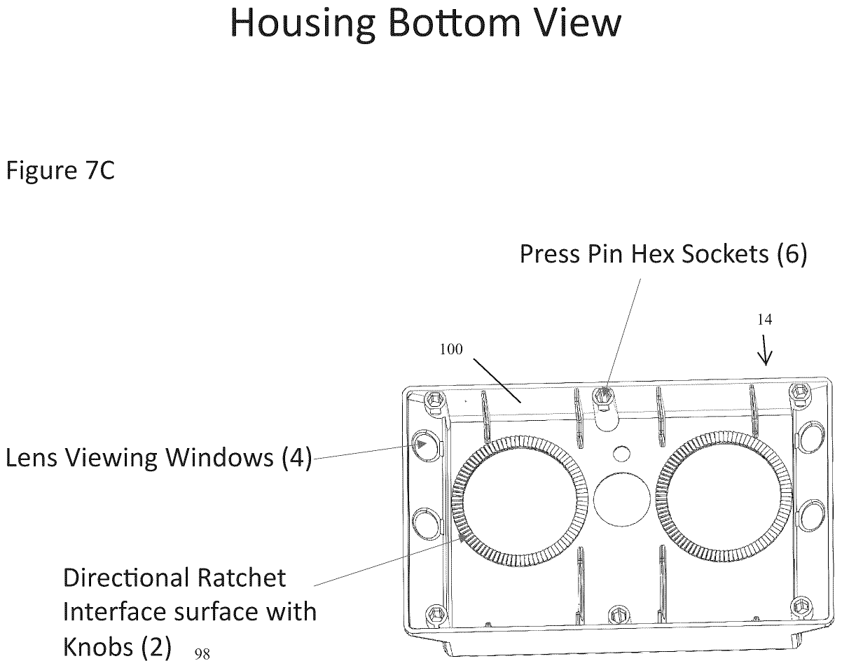

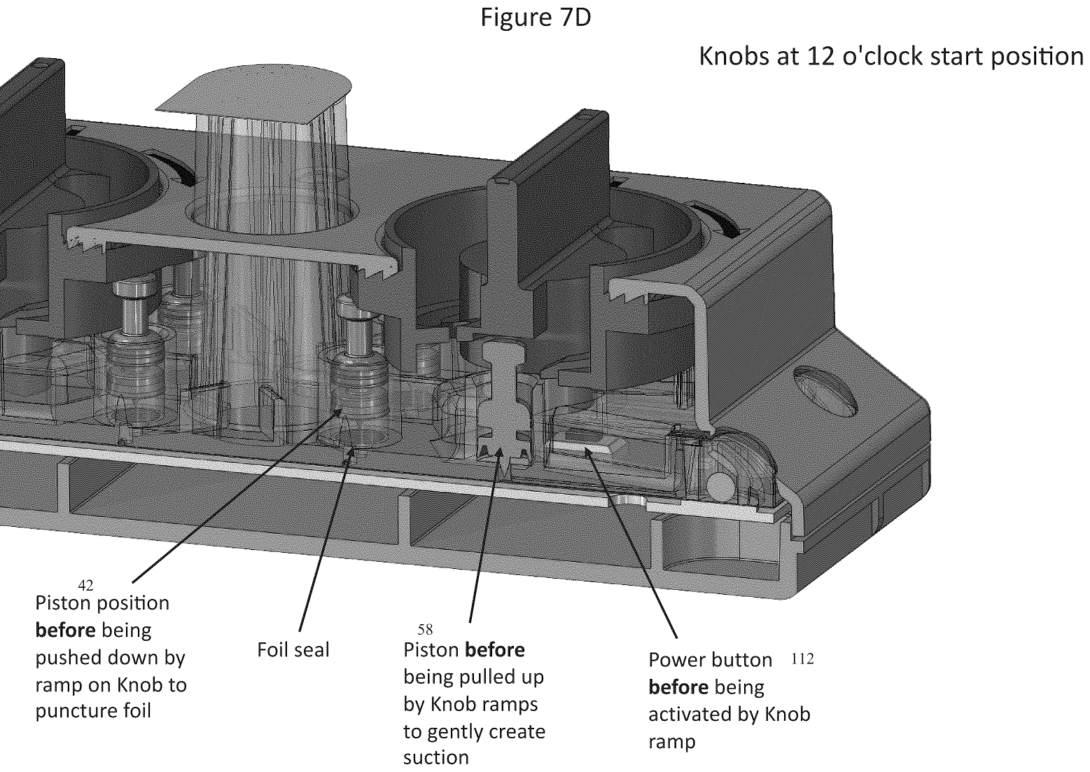

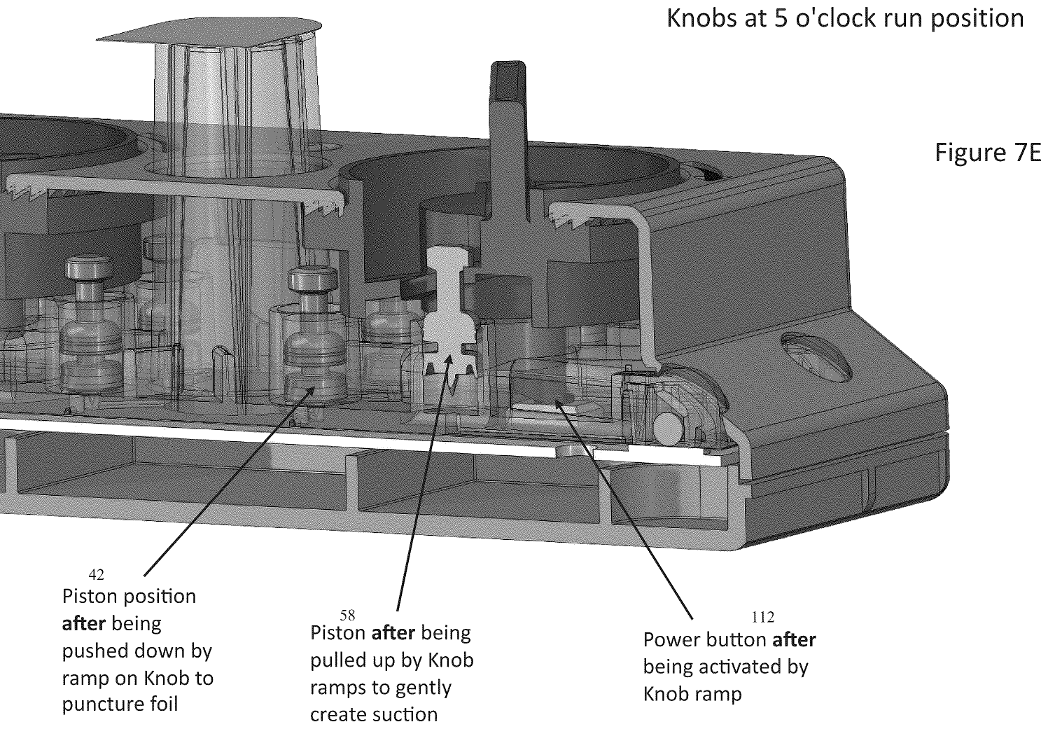

FIGS. 6, 7A, 7B, 7C, 7D, and 7E show an embodiment of an assay device including a pair of controller elements 22 (e.g., knobs) used as described herein. In this example, each of the knobs comprises a plurality of ratcheting teeth 90 disposed on a surface of the knobs that interact with a corresponding structure of a housing of the device shown in FIG. 7C. The ratcheting teeth 90 provide tactile feedback (e.g., by clicking or progressively engaging the corresponding structure of the housing of the device). The ratcheting teeth 90 also allow the knobs 22 to be rotated in a first direction (e.g., in a clockwise direction) and prevent the knobs 22 from being rotated in a second direction (e.g., in a counterclockwise direction). The ratcheting teeth 90 can also lock the knobs 22 in place after being turned to a predetermined position (e.g., a five o'clock position). FIG. 7A shows a bottom view of the knobs 22 and mounting substrate 14 shown in FIG. 6. A bottom surface of the knobs 22, which is adapted to extend at least partially through the mounting substrate 14 as shown in FIG. 7A, has a ramped surface 92 that moves as the knob 22 is rotated. The ramped surface 92 of the knob 22 may be designed to perform one or more functions. For example, the ramped surface 92 may engage a switch (e.g., a power switch) on a printed circuit board assembly disposed below the mounting substrate. As discussed earlier, the ramped surface 92 may also be used to actuate piston motion, connecting the sample well with the dry side channel 82 leading to the reaction well 32 and creating negative pressure within the reaction wells 32, thereby providing a metered/consistent amount of fluid in the reaction wells 32. The bottom view of the mounting substrate 14 also shows a plurality of microfluidic channels disposed on a bottom surface of the mounting substrate. A fluid path 94 from the sample well 28 to the reaction well 32, and a suction path 96 from the reaction well 32 are shown, for example.

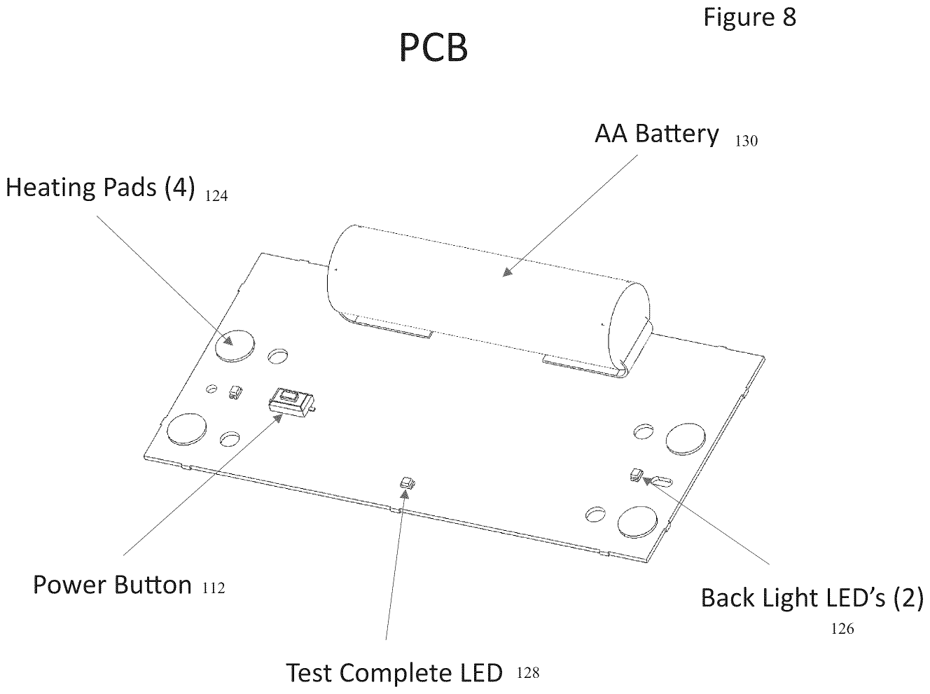

FIG. 7B shows an embodiment of a manual knob controller 22 adapted for use within the microfluidic device 10. In this embodiment, the knob 22 includes the plurality of directional ratchet teeth 90 that engage with the corresponding plurality of ratchet interface surfaces 98 disposed on the inner surface 100 of the housing 14 around the knob openings as shown in FIG. 7C. The knob controller 22 also includes a pair of syringe piston ramps 102 that engage a collar 104 of each of the pair of syringe pistons shown in FIG. 4. The sloped syringe piston ramps 102 extend under the collars 104 of the suction path syringe pistons 58 and slope upwardly as the knob controller 22 is rotated such as shown in FIGS. 7D and 7E. As the knob controller 22 is rotated, each of the pair of suction syringe pistons 58 are raised within the syringe piston cylinders (shown in FIG. 7E) creating negative pressure (suction) to draw a consistent, metered amount of the fluid into the reaction well 32. The knob controller 22 also includes a pair of puncture piston ramps 106 that slope downwardly as the knob controller 22 is rotated. The puncture piston ramps 106 engage the top surface 108 of each of the pair of puncture pistons 42 as shown in FIGS. 7D and 7E, driving the puncture pistons 42 downwardly within the puncture piston cylinders (shown in FIG. 7E) and the foil puncture spike through a frangible seal disposed along a bottom surface of the puncture piston cylinder to communicatively couple the wet side 80 and dry side 82 channels formed in the substrate and connecting the sample well 28 to each of the reaction wells 32 as described above with respect to FIG. 5B. Then, as the suction syringe piston 58 is withdrawn within its syringe piston cylinder, the piston creates negative pressure (suction) in the reaction well 32 through the metering syringe channel to draw a consistent, metered amount of fluid sample into the reaction well 32. At least one of the knob controllers 22 also has a power button ramp 110 that is adapted to provide downward pressure to a power switch 112 on a printed circuit board as described further with respect to FIG. 8.

FIG. 8 shows an embodiment of a printed circuit board (PCB) 120 that may be disposed within a device housing 12, such as below the mounting substrate 14 shown in FIG. 6. In this embodiment, the PCB 120 comprises a microprocessor 122, a heating element 124 for heating a reaction well, a “heater on” indicator LED 126 showing the status of the heating pad 124, and a ready LED 128 for indicating when one or more assays are complete. The PCB 120 also includes a switch 112 that is engageable by the knob ramped surface described with reference to FIG. 7 and adapted to power on the microprocessor 122 of the PCB 120. The microprocessor 122, in turn, is adapted to control the heating element 124 and various indicator lights 126, 128. A battery 130 is also shown in FIG. 8. Although a typical AA disposable battery is shown, any type of disposable or rechargeable power supply may be used.

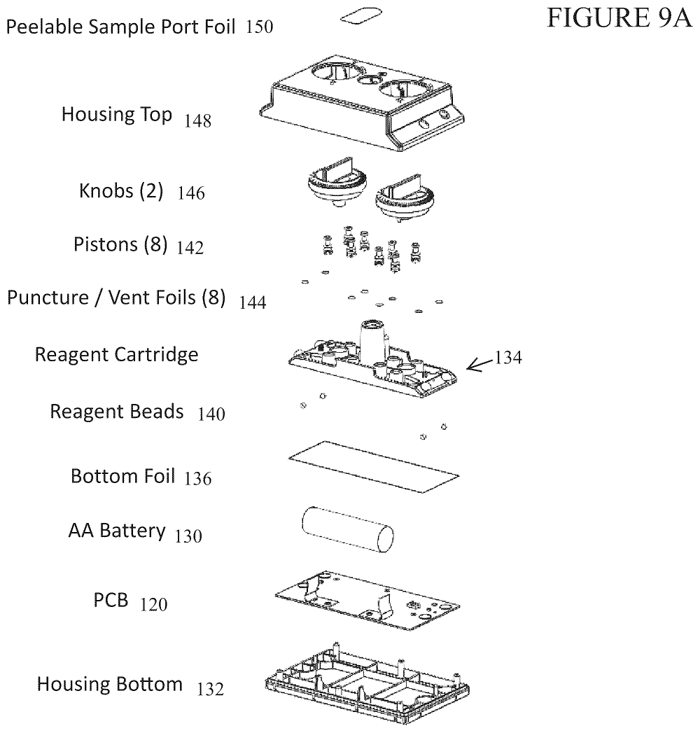

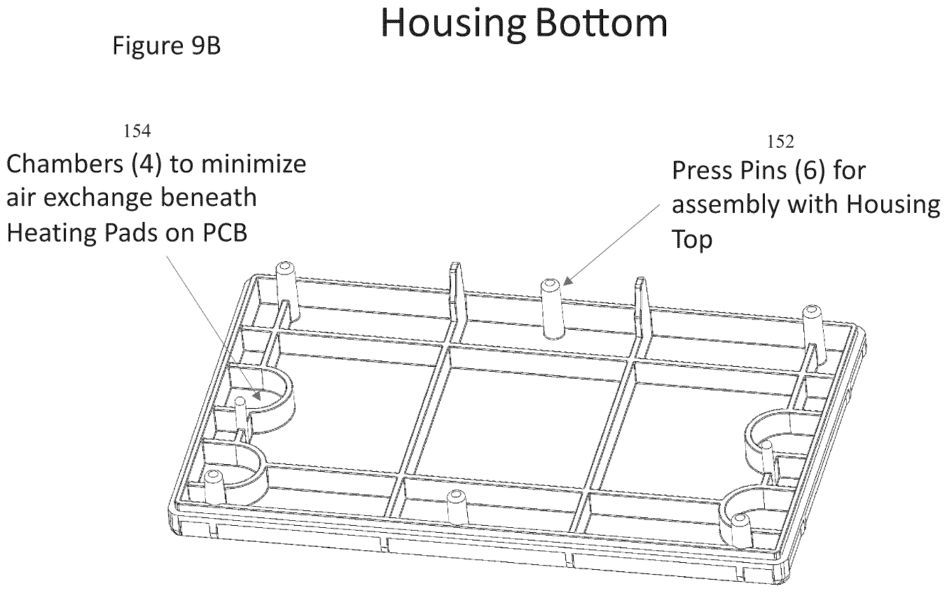

FIG. 9A is an exploded view of an embodiment of a microfluidic device. In this embodiment, a PCB 120 is mounted to a housing bottom 132. A battery 130 or other energy storage device can be mounted to the PCB 120 or otherwise housed within the housing. A substrate 134 (e.g., a mounting substrate or cartridge) provides the fluid handling components of the microfluidic device in combination with a bottom foil 136 sealed across one or more bottom surfaces 138 of the substrate 134. One or more reagent beads 140 (e.g., lyophilized beads) are disposed within one or more reaction wells. A plurality of pistons 142 and puncture or vent foils 144 are disposed within cylinders formed in the substrate 134 as described with respect to FIG. 5B. A pair of knob controllers 146 as described with reference to FIGS. 5B, 7A and 7B are also shown. A housing top 148 is mounted to the housing bottom, and a sample port foil 150 is disposed on a sample well cylinder of the substrate that extends through the housing top to provide a sample port.

FIG. 9B is a perspective view of the housing bottom shown in FIG. 9A. The housing bottom 132 and the housing top 148 enclose the various components of the microfluidic device. The housing bottom 132 includes one or more air chambers 154 adapted to reduce air exchange near heating pads disposed on the PCB 120 and thus reduce heat loss within the reaction well(s) and reduce heat transfer to other components or regions of the microfluidic device. The housing bottom 132 also includes press pins 152 for assembly with the housing top and one or more mounting pins or receptacles for securing the PCB 120 within the microfluidic device.

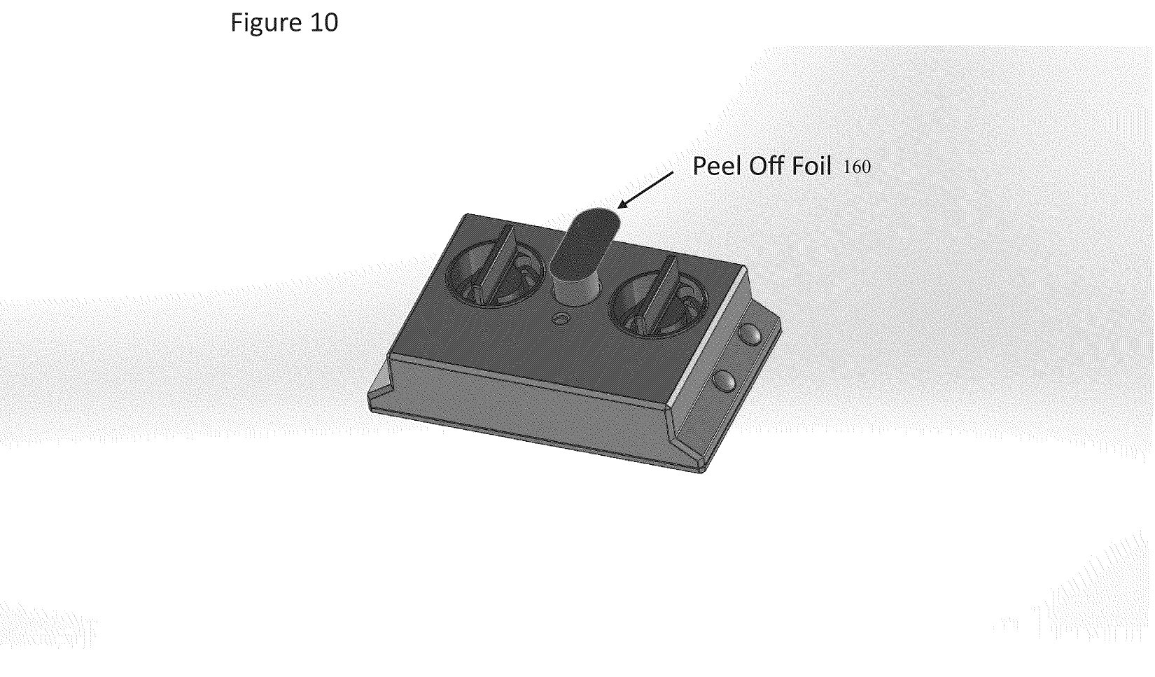

FIGS. 10 through 14 show an example of a process for performing an assay. In FIG. 10, a foil layer covering the sample entry port is removed 160 to expose the sample well located at the bottom of the entry port. As described above, the foil may be removed in whole or in part, or may be pierced, such as by a sample swab being inserted through the foil layer or by an instrument being inserted through the foil layer.

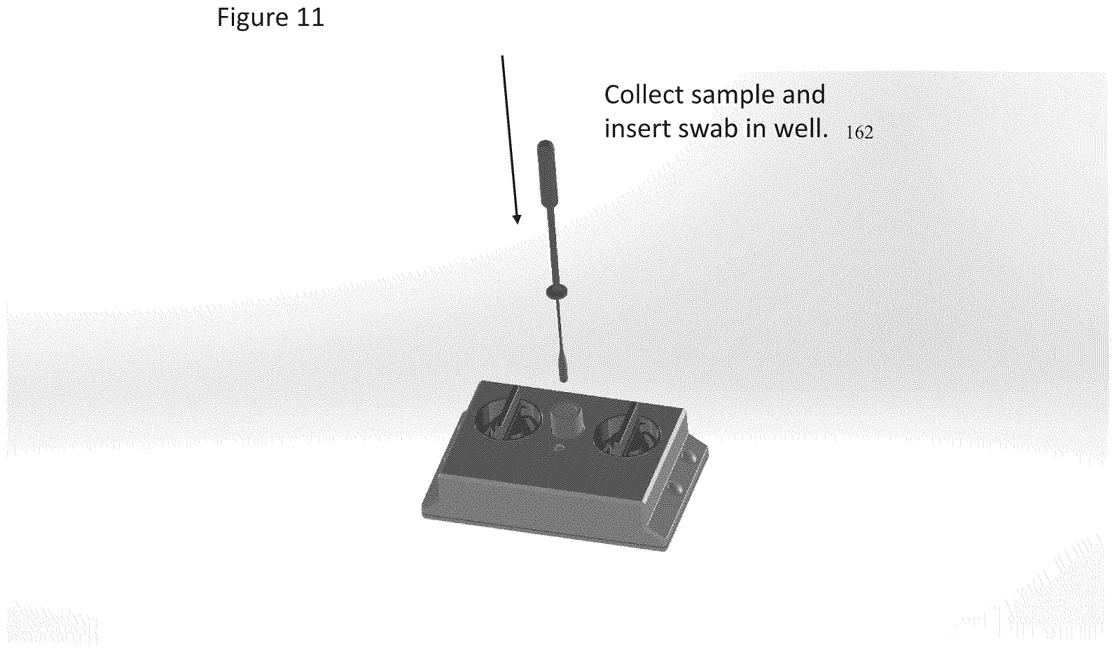

FIG. 11 shows a swab including a sample taken from a patient being inserted through the sample entry port and into the sample well 162. The swab is inserted into the sample well and at least partially submerged in the extraction mixture and mixed to transfer sufficient sample to the extraction mixture. In some embodiments, the sample well may include at least one surface adapted to engage the swab to aid in mixing of the sample and the extraction mixture by scraping or otherwise engaging with the swab.

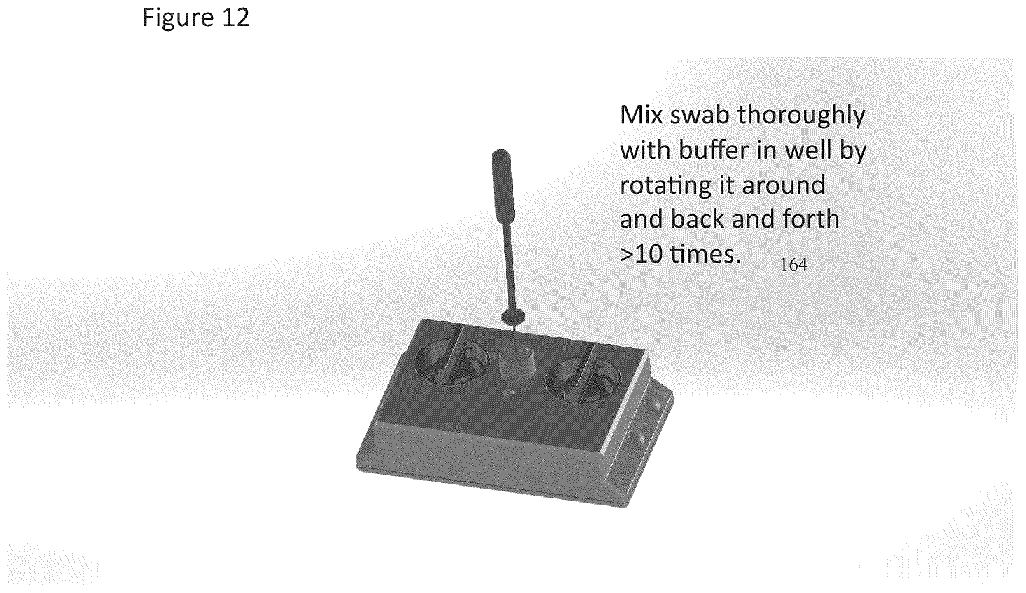

FIG. 12 shows the swab being mixed with the extraction mixture 164, such as by rotating the swab back and forth within the sample well a number of times (e.g., >5 times).

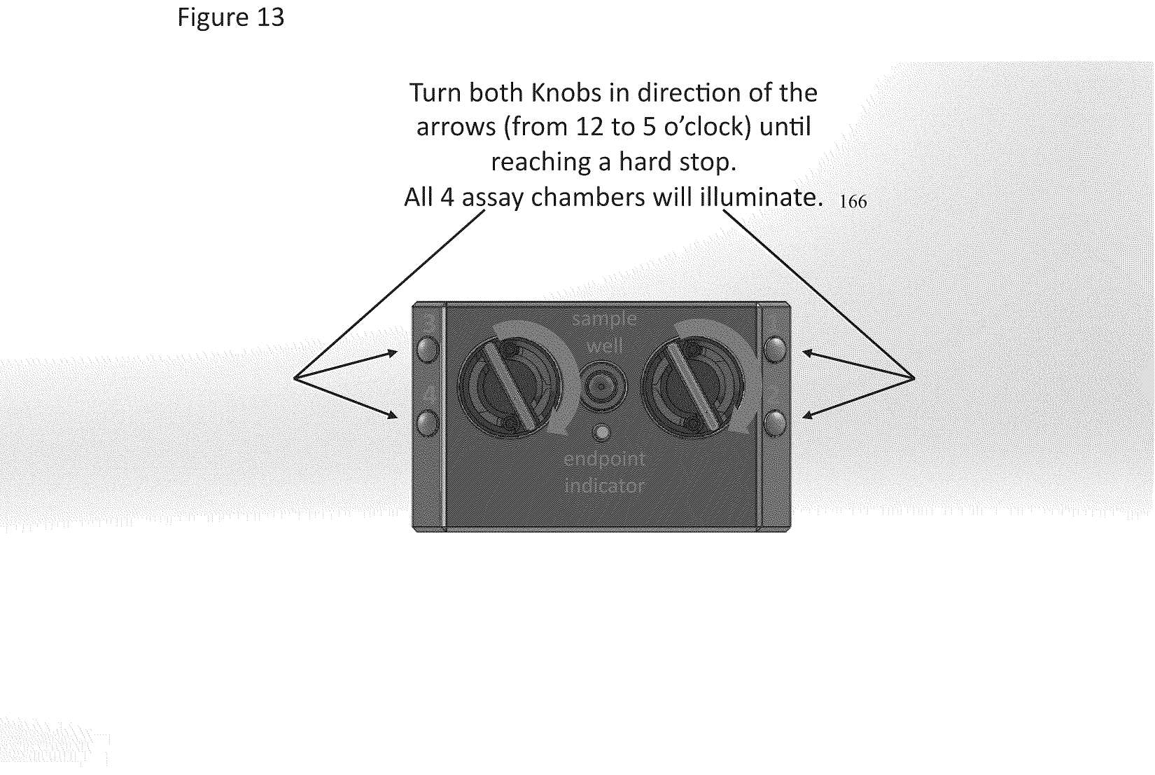

FIG. 13 shows each of a pair of knobs being rotated from a starting position to an ending position 166 (e.g., from a 12 o'clock to a 5 o'clock position). At the ending position, a hard stop provided by the device (e.g., on the mounting substrate), a power switch may be engaged and indicator lights (e.g., LEDs) for all or a portion of the reaction wells may be illuminated to indicate that the sample has been delivered to the respective reaction wells.

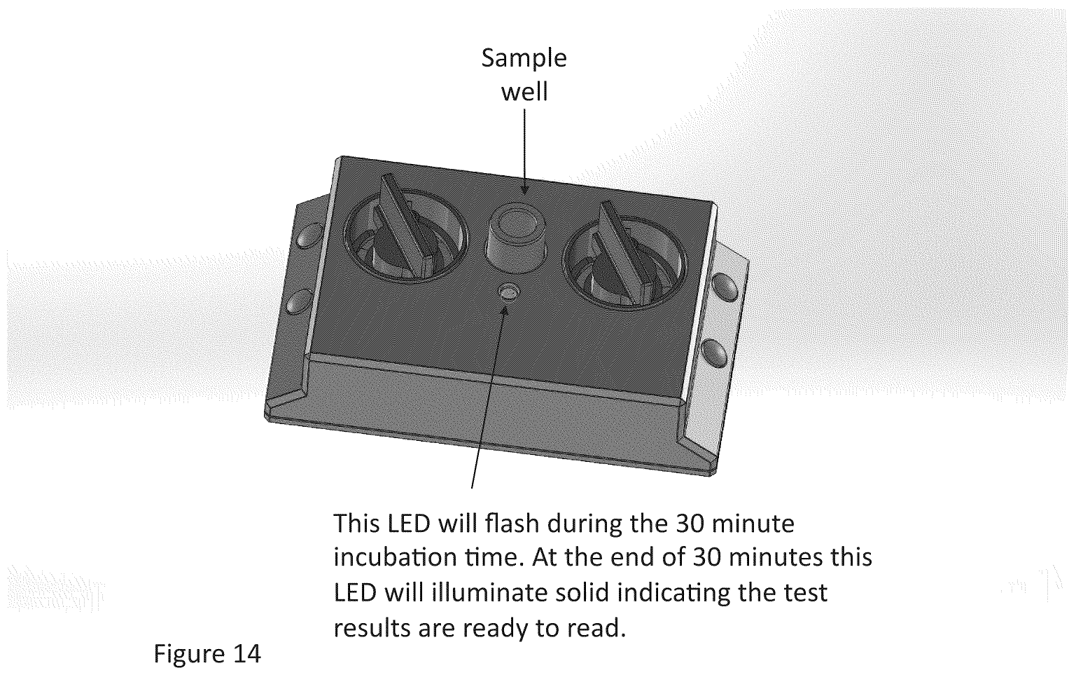

FIG. 14 shows an indicator (e.g., an LED indicator) being illuminated to indicate that the assay is complete 168. The indication, for example, may indicate that a predetermined time for the assay has expired.

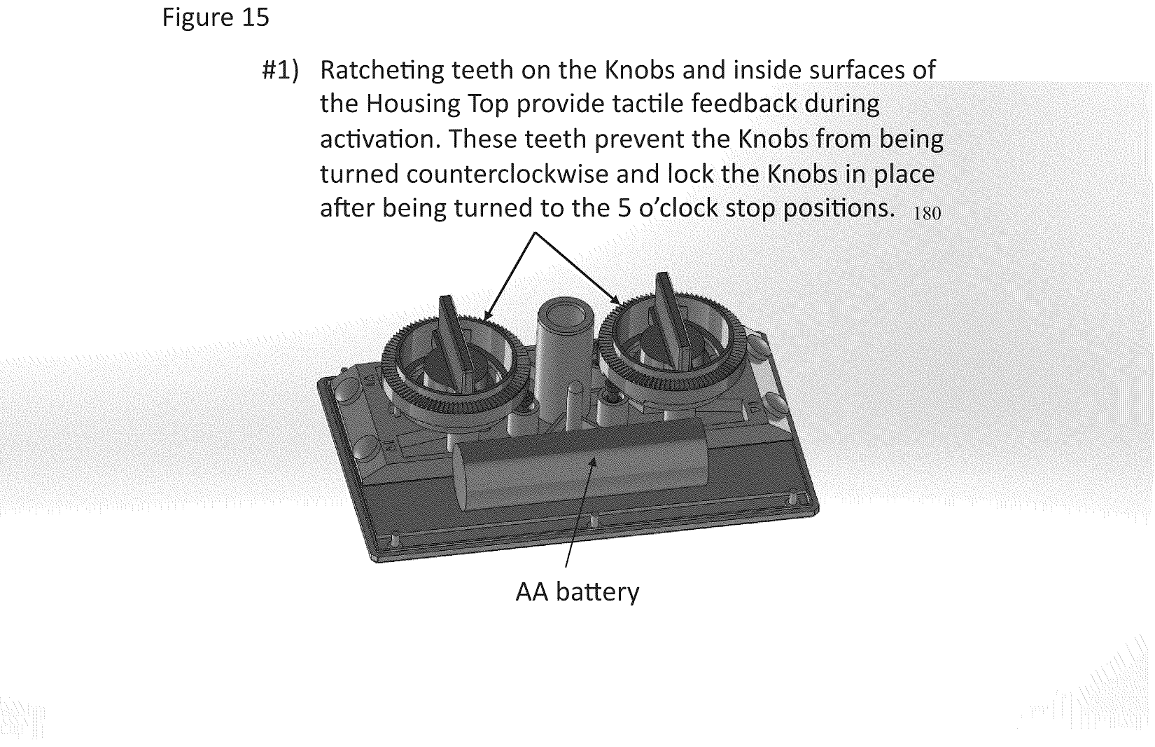

FIGS. 15 through 19 show an example embodiment of an assay device in which a pair of knobs are rotated to initiate the assay as described herein. In FIG. 15, a plurality of ratcheting teeth on a surface of the knobs and corresponding surfaces (e.g., a corresponding set of ratcheting teeth) disposed on or within the housing engage as the knobs are rotated 180. The interacting teeth and corresponding structures can provide a tactile feedback as the knobs are rotated (e.g., by clicking as the knob is rotated). The teeth may also be configured to allow a single direction of movement (e.g., in a clockwise direction) and prevent the knobs from being turned in an opposite direction (e.g., in a counterclockwise direction).

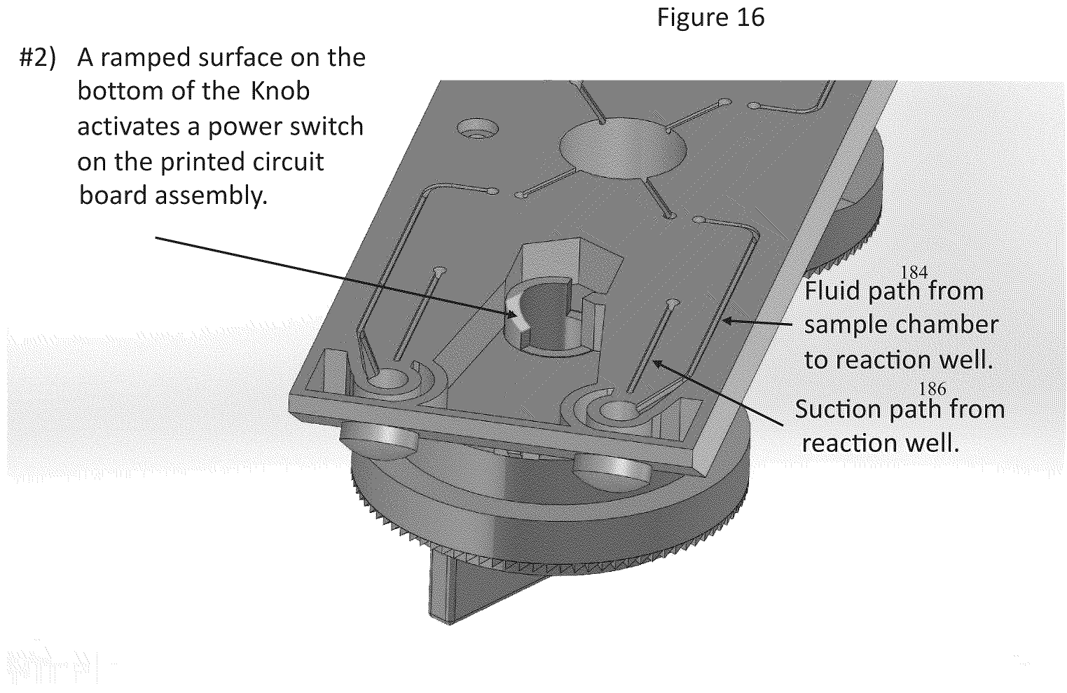

FIG. 16 shows a ramped surface 182 disposed on a lower portion of the knobs. As the knob is rotated the furthest extending portion of the ramped surface 182 can be brought into engagement with a switch on a PCB of the assay device, such as shown in FIG. 8. FIG. 16 also shows a plurality of microfluidic channels 184, 186 connecting the sample well and reaction well and providing a suction path from the reaction well.

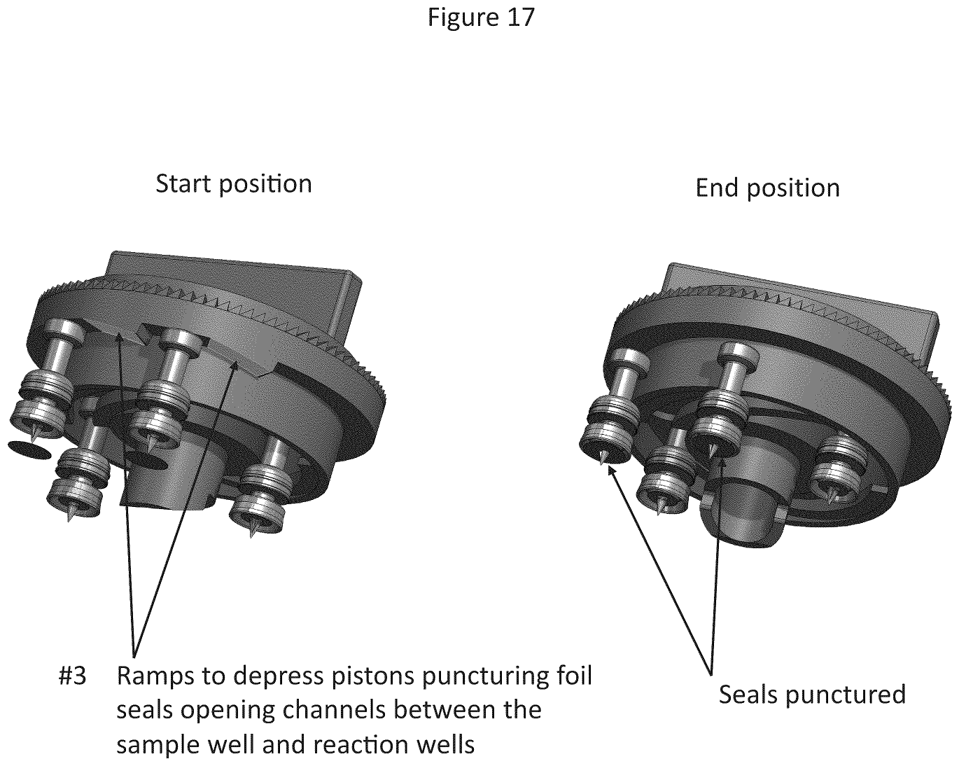

FIG. 17 shows a knob having another ramped surface 188 adapted to engage at least one piston as described above. As the knob is turned, the ramped surface progressively depresses the piston(s) to puncture foil seals disposed between the sample well and reaction well.

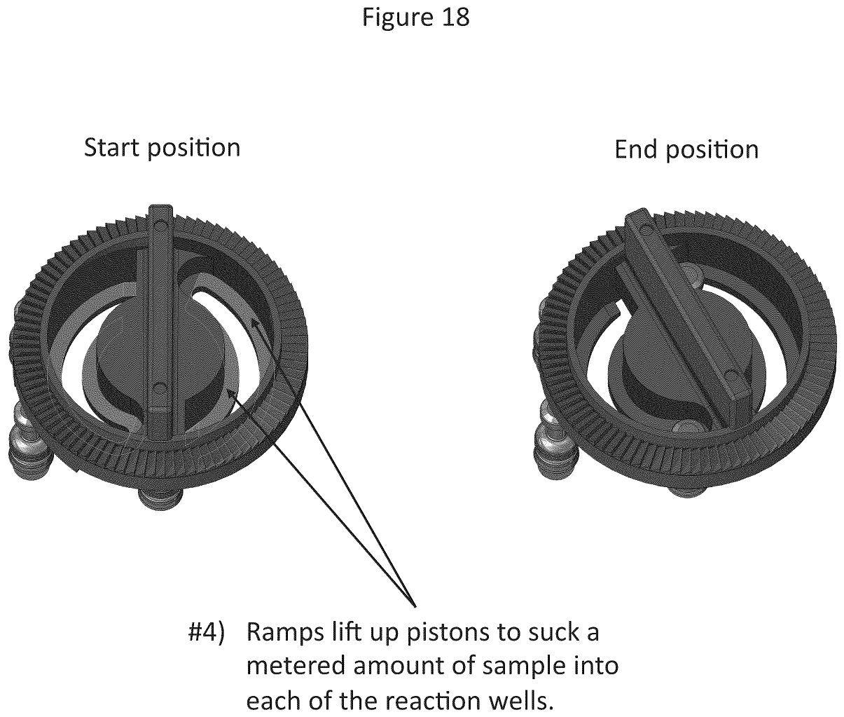

FIG. 18 shows a pair of knob controllers each having a respective pair of syringe piston ramps 190 adapted to lift a corresponding syringe piston a predetermined amount as described with reference to FIG. 7B wherein the extent of the piston's movement provides suction sufficient to deliver a reproducible amount of the sample fluid into each of the respective reaction wells.

### MODES OF CARRYING OUT AN ASSAY

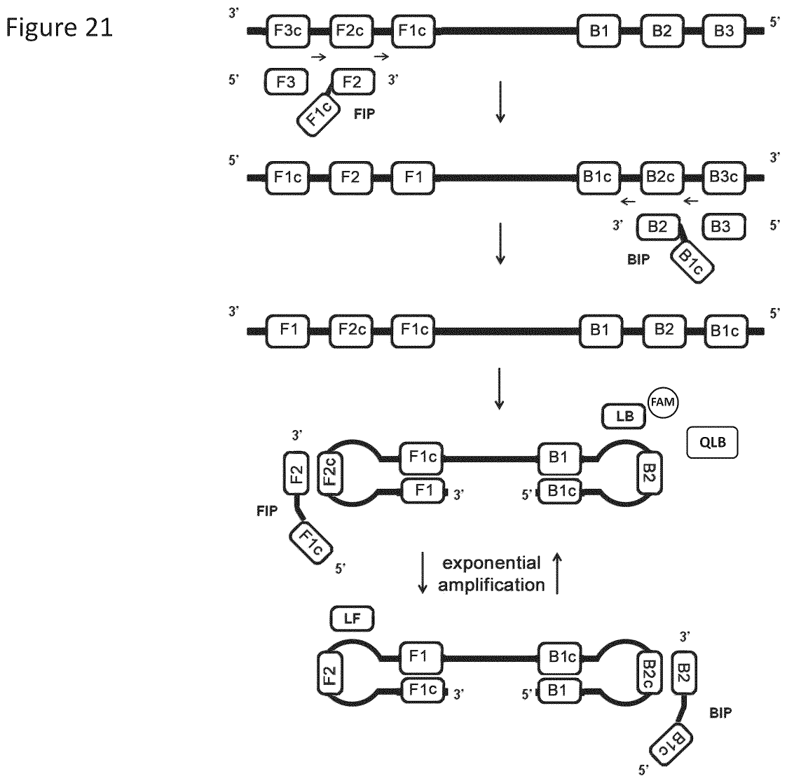

LAMP (loop-mediated isothermal amplification) assay: The LAMP assay shown schematically in FIG. 21 uses 4-6 primers recognizing distinct regions of target DNA. A strand-displacing DNA polymerase initiates synthesis and two of the primers form loop structures to facilitate subsequent rounds of amplification. Optionally, two additional loop primers provide additional sites for amplification synthesis initiation.

In one example, reactions are carried out in 25 μL volumes containing: WarmStart RT-LAMP master primer mix (New England Biolabs; Ipswich, MA); molecular grade water (Sigma); and template. Reactions are mixed and incubated at 65° C. for 30 min, e.g. in a thermocycler held at a constant temperature, such as the AriaMx Real-time PCR System from Agilent (Santa Clara, CA). These conditions mimic the conditions in a point-of-care assay reaction well.

Endpoint readout may be fluorescent for which an assay readout can use SYBR green which becomes fluorescent when intercalated between stacked DNA bases, making the signal proportional to the amount of DNA present {Hu Y, Wan Z, Mu Y, Zhou Y, Liu J, Lan K, Zhang C. A quite sensitive fluorescent loop-mediated isothermal amplification for rapid detection of respiratory syncytial virus. J Infect Developing Countries. 2019 Dec. 31; 13(12):1135-1141; Le Thi N, Ikuyo T, Nguyen Gia B, Truong Thai P, Vu Thi T V, Bui Minh V, Dao Xuan C, Le Trung D, Phan Thu P, Do Duy C, Pham The T, Do V T, Pham Thi P T, Ngo Quy C, Dang Quoc T, Jin T, Shohei S, Takato O, Noriko N, Tsutomu K. A clinic-based direct real-time fluorescent reverse transcription loop-mediated isothermal amplification assay for influenza virus. J Virol Methods. 2020 March; 277:113801}. Optionally, for assay validation the LAMP products can be confirmed to be of correct size by running the amplified DNA on a 1-1.5% agarose gel in 5 mM lithium metaborate buffer at 3.5V/cm and visualized by ethidium bromide staining compared to a ladder of sizing standards.

Malachite Green is an intercalating dye which does not require UV excitation. This dye is compatible with LAMP assays {Nzelu C O, Gomez E A, Caceres A G, Sakurai T, Martini-Robles L, Uezato H, Mimori T, Katakura K, Hashiguchi Y, Kato H. Development of a loop-mediated isothermal amplification method for rapid mass-screening of sand flies for Leishmania infection. Acta Trop. 2014 April; 132:1-6}.

An alternative to intercalating dyes and fluorescents is provided by use of fluorescein amidites (FAM). In this approach, a labelled loop probe is quenched in its unbound state but fluoresces when bound to its target. This approach reduces non-specific signals arising from unintentional duplex DNA formation when using a large mixture of primers, or degenerate primers, to encompass a family of targets {Gadkar V J, Goldfarb D M, Gantt S, Tilley P A G. Real-time Detection and Monitoring of Loop Mediated Amplification (LAMP) Reaction Using Self-quenching and De-quenching Fluorogenic Probes. Sci Rep. 2018 Apr. 3; 8(1):5548}. Conversely, the fluor can be quenched upon binding {Le Thi N, Ikuyo T, Nguyen Gia B, Truong Thai P, Vu Thi T V, Bui Minh V, Dao Xuan C, Le Trung D, Phan Thu P, Do Duy C, Pham The T, Do V T, Pham Thi P T, Ngo Quy C, Dang Quoc T, Jin T, Shohei S, Takato O, Noriko N, Tsutomu K. A clinic-based direct real-time fluorescent reverse transcription loop-mediated isothermal amplification assay for influenza virus. J Virol Methods. 2020 March; 277:113801}.

Colorimetric probes can also be used in LAMP assays, specifically a dye that changes color as the reaction mixture pH drops due to liberation of pyrophosphate and hydrogen ions during DNA polymerization {Tanner N A, Zhang Y, Evans T C Jr. Visual detection of isothermal nucleic acid amplification using pH-sensitive dyes. Biotechniques. 2015 Feb. 1; 58(2):59-68}. In one embodiment, cresol red can be used.

A FET (field effect transistor) chip can also be used for pH change detection in LAMP {See, e.g., Salm E, Zhong Y, Reddy B Jr, Duarte-Guevara C, Swaminathan V, Liu Y S, Bashir R. Electrical detection of nucleic acid amplification using an on-chip quasi-reference electrode and a PVC REFET. Anal Chem. 2014 Jul. 15; 86(14):6968-75}.

An alternative colorimetric readout relies on detection of free Mg⁺⁺ which decreases after forming a complex with pyrophosphate as nucleotides become incorporated into DNA. Hydroxynaphthol blue and calcein have both been used for this purpose {Suebsing R, Kampeera J, Tookdee B, Withyachumnarnkul B, Turner W, Kiatpathomchai W. Evaluation of colorimetric loop-mediated isothermal amplification assay for visual detection of Streptococcus agalactiae and Streptococcus iniae in tilapia. Lett Appl Microbiol. 2013 October; 57(4):317-24}. Alternatively, the turbidity arising from precipitation of magnesium-pyrophosphate can be measured.

Extraction Mixture. Swabs are exposed to extraction mixture which can be formulated to include buffers and denaturants or lytic agents, such as non-ionic detergents, that act to liberate the viral nucleic acid (in some embodiments) from the viral capsid as well as divalent cation chelators, such as EDTA, to suppress nucleases in the sample. Broad specificity protease, glycosidase and lipase enzymes may also be included to reduce sample matrix interference; if such enzymes are temperature sensitive, inactivation is achieved when temperature is raised to 65° C. either in the reaction well or in transit from the sample well to the reaction well. Chaotropic agents, such as guanidine hydrocholoride may also be included. The insensitivity of the LAMP enzymes to interfering substances facilitates use of saliva as the sample, rather than the more invasive nasal swab. The extraction mixture may also serve to inactivate live virus. Regarding sample collection for CoV2 assays, the US Centers for Disease Control (CDC) has issued recommendations {See, e.g., https://www.cdc.gov/urdo/downloads/SpecCollectionGuidelines.pdf}.

Dried assay reagents: In one embodiment, the assay reagent mixture, dissolved in an aqueous solution of excipients to provide reagent stability as well as mechanical strength to the beads, includes the primers and 4× concentrated WarmStart assay reagents for a fluorescence assay and 5× concentrated WarmStart assay reagents for a colorimetric assay, and in some embodiments may optionally include positive controls. The liquid is delivered through a nozzle under positive pressure to create droplets of approximately 2.7 to 3.1 mm diameter (approximately 10 to 15 microliters, respectively) that fall into a liquid nitrogen receiving vessel. The frozen beads are distributed on a flat surface at low enough density that >90% of the beads are at least one 1 mm apart from any other bead. The liquid nitrogen is allowed to evaporate, after which the frozen droplets are lyophilized (freeze-dried) in place. Using these methods, −200,000 beads can be readily produced daily. The resulting beads are mechanically sturdy enough to be collected, including filtering through a meshwork to eliminate aggregates of two or more beads. Dispensing of the dried spherical beads into reaction wells can be accomplished using a vacuum tweezer or similar instrument.

Multiple analyte assay. All SARS-CoV-2 genomes in the virus pathogen database (viprbrc.org) were aligned using Clustal W in BioEdit to identify highly conserved regions >15 nucleotides in the alignment. Nucleic acid targets that are widely used to detect SARS-CoV-2 include SARS-CoV-2 nucleocapsid (N) gene (N gene) and the open reading frame of lab (ORFlab) either of which could be used. The conserved regions in the viral N gene are useful for selecting RT-LAMP primers using primerexplorer.jp/e ver 5.0. These RT-LAMP primers permit direct comparison with PCR data. See Table 1 for suitable CoV2 sequences. Primers for influenza have been previously described: {Le Thi N, Ikuyo T, Nguyen Gia B, Truong Thai P, Vu Thi T V, Bui Minh V, Dao Xuan C, Le Trung D, Phan Thu P, Do Duy C, Pham The T, Do V T, Pham Thi P T, Ngo Quy C, Dang Quoc T, Jin T, Shohei S, Takato O, Noriko N, Tsutomu K. A clinic-based direct real-time fluorescent reverse transcription loop-mediated isothermal amplification assay for influenza virus. J Virol Methods. 2020 March; 277:113801}.

The following examples are offered to illustrate but not to limit the invention.

TABLE 1
LAMP primers for CoV2.

| PRIMER | SEQUENCE (5′-3′) |
|---|---|
| COVID- | TCTGGCCCAGTTCCTAGGTAGTGACGAATTCGTGGTGGTGA |
| FIP | |
| COVID- | AGACGGCATCATATGGGTTGCACGGGTGCCAATGTGATCT |
| BIP | |
| COVID- | TGGCTACTACCGAAGAGCT |
| F3 | |
| COVID- | TGCAGCATTGTTAGCAGGAT |
| B3 | |
| COVID- | GCCATTTACTTTCTAGAGTCAGGT |
| LF | |
| COVID- | ACTGAGGGAGCCTTGAATAC |
| LB | |

### EXAMPLES

### Example 1: RT-LAMP Assay Validation vs PCR

Limit of Detection (LoD) testing was performed with genomic RNA from the N gene of SARS-CoV-2. The RNA was serially diluted in extraction mixture (0.2% Triton X-100, 1.0 mM EDTA, 50 mM guanidine HCl in sterile water) and tested in triplicate. The LoD was determined as the lowest concentration with ≥75% detection. For a fluorescent assay using SYBR green as the readout, the LoD was 25 viral genome copies per sample (25 μL). For a colorimetric assay using cresol red as the readout, the LoD was 100 viral genome copies per sample (25 μL).

Sensitivity was equivalent for SARS-CoV-2 B.1.1.7 variant (20I/501Y.V1) and wild-type SARS-CoV-2 (USA-WA1/2020). RNAs of coronaviruses from three other human coronaviruses, which are not associated with mortality, were used as negative controls at 500 copies per sample to test the specificity of the assay: OC43 (GenBank: AY585228.1), 229E (GenBank: AF304460.1), and NL63 (GenBank: AY567487.2). None of these samples scored as positive in the assay.

Samples containing live SARS-CoV-2 virus, from the Georgia COVID-19 Task Force, were assayed by RT-LAMP and results compared to PCR. The cutoff for PCR true positives, as recommended by the CDC, was set at Ct<30. As shown in Table 3, concordance was 97%; for Ct>30, concordance was 65%. For PCR true negatives (no signal), concordance was 98%; For 9 samples with Ct>40 (false positives), there was no concordance. In short, RT-LAMP is a more reliable assay than PCR. That is, PCR requires data analysis to distinguish true positives from false positives.

TABLE 2
LAMP sensitivity compared to RT-PCR for CoV2 mRNA.

| mRNA | LAMP (SYBR) | LAMP (cresol) | |
|---|---|---|---|
| genome | fluorescent assay | colorimetric assay | CDC RT-PCR |
| equivalents | Detected/Tested | Detected/Tested | Detected/Tested |
| 25 | 15/20 (75%) | 5/20 (25%) | 7/20 (35%) |
| 100 | 5/5 (100%) | 5/5 (100%) | 5/5 (100%) |
| 250 | 5/5 (100%) | 5/5 (100%) | 5/5 (100%) |

TABLE 3
Comparison of RT-LAMP to RT-PCR on clinical samples.

| | Detected/Tested |
|---|---|
| Georgia COVID-19 | (SYBR green assay) |
| Task Force Samples | (% Agreement) |
| Retrospective: Positive | 29/30 (97%) |
| Retrospective: Negative | 1/59 (98%) |

In a variation of the RT-LAMP Assay Validation example, improved signal to noise and sensitivity is provided by using fluorescein amidites (FAM) with a fluorescence quencher. In this approach, a labelled loop probe is quenched in its unbound state but fluoresces when bound to its target. Suitable primers and probes for CoV2 are provided in Table 4 [numbering according to CoV2 Wuhan-Hu-1 (GenBank: MN908947.3)]. See FIG. 21 for terminology in naming the primers; FAM label is attached to the LB primer in this format, with the quenching QLP oligonucleotide free in solution. Sensitivity was assessed using CoV2 virus grown in cell culture, serially diluted (Table 5).

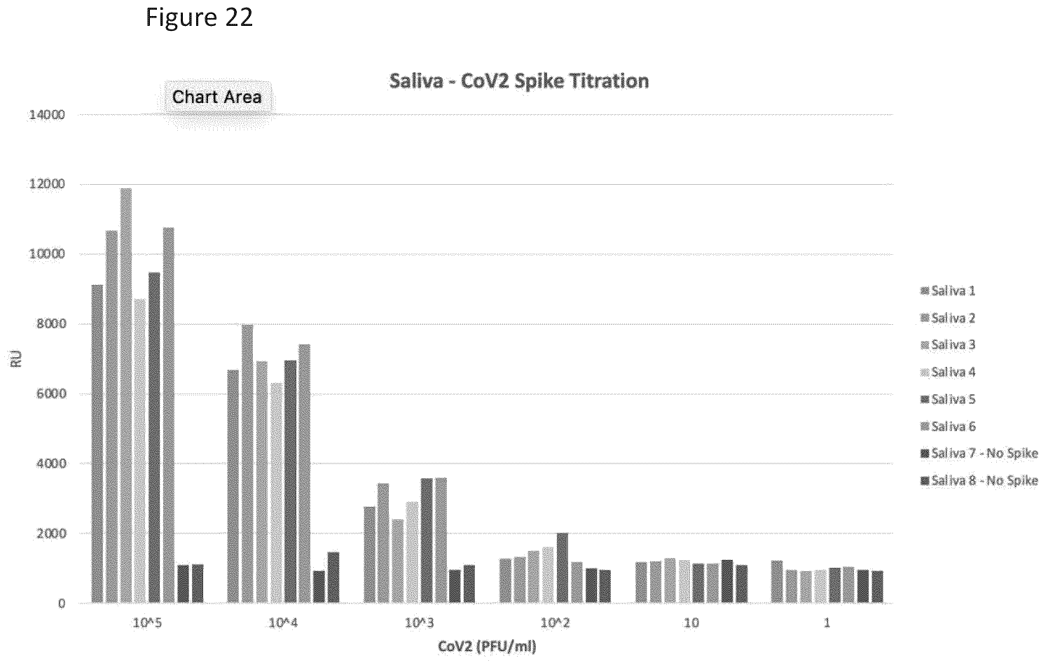

To test this assay further, 50 μL of saliva (from a pre-pandemic archive) was pipetted into the well of a 96-well PCR plate with Proteinase K (10 U/mL) and adjusted to pH 7.5 with 30 mM Tris-HCl, then spiked with WA1-CoV2 cell culture supernatant. After incubation for 15 minutes at 50° C., the Proteinase K was inactivated by heating to 95° C. for 5 minutes; 10 μL of the material was transferred to the FQ-LAMP (15 μL) reaction (25 μL total volume), and LAMP analysis performed. The assay was conducted in 6 replicates, with two replicates of negative control (no added virus). The results are shown in FIG. 22. Adjusting for dilutions, the assay sensitivity limit was 1000 PFU/mL in the original spike.

TABLE 4
CoV2 N gene-based FQ-LAMP primers and signal
oligos.

| | | Genome |
|---|---|---|
| NAME | SEQUENCE (5′-3′) | Position |
| COVID-F3 | TGGCTACTACCGAAGAGCT | 28525-28543 |
| COVID-B3 | TGCAGCATTGTTAGCAGGAT | 28722-28741 |
| COVID-LF | GCCATTTTACTTTCTAGAGTCAGGT | 28567-28591 |
| COVID-LB | [6FAM]ACTGAGGGAGCCTTGAATAC | 28676-28695 |
| COVID-FIP | GACGAATTCGTGGTGGTGA | 28548-28566 |
| (F1c) | | |
| COVID-FIP | TCTGGCCCAGTTCCTAGGTAGT | 28605-28626 |
| (F2) | | |
| COVID-BIP | CGGGTGCCAATGTGATCT | 28702-28719 |
| (B1c) | | |
| COVID-BIP | AGACGGCATCATATGGGTTGCA | 28654-28675 |
| (B2) | | |
| COVID-QLB | GCTCCCTCAGT[IBHQ] | 28676-28686 |

TABLE 5
Fluorescence Quenched LAMP assay sensitivity.

| CoV2 (WA1) | FQ-LAMP |
|---|---|
| PFU/mL | Fluoresence units |
| 10⁶ | 14,046 ± 279 (±2.0%) |
| 10⁵ | 14,089 ± 357 (±2.5%) |
| 10⁴ | 13,811 ± 376 (±2.7%) |
| 10³ | 8,069 ± 550 (±6.8%) |
| 10² | 2,716 ± 409 (±15.1%) |
| 500 | 4,106 ± 488 (±11.9%) |
| 250 | 2,854 ± 456 (±16.0%) |
| 125 | 2,163 ± 466 (±21.6%) |
| 63 | 1,244 ± 233 (±18.8%) |
| 32 | 990 ± 75 (±7.7%) |
| No template control | 1,235 ± 281 (±22.8%) |

### Example 2: Point of Care Single Sample Format

A point of care device has been constructed that embodies the innovative elements noted above. The microfluidic device of the present invention may comprise a mounting substrate in which various microfluidic elements are disposed. The mounting substrate includes an exterior portion or surface, as well as an interior portion which defines the various microscale channels and/or chambers of the overall microfluidic device. For example, the mounting substrate of exemplary microfluidic devices typically employs a solid or semi-solid substrate that may be planar in structure, i.e., substantially flat or having at least one flat surface. Suitable substrates may be fabricated from any one of a variety of materials, or combinations of materials. Often, the planar substrates are manufactured using solid substrates common in the fields of microfabrication, e.g., silica-based substrates, such as glass, quartz, silicon, or polysilicon, as well as other known substrates, i.e., gallium arsenide. In the case of these substrates, common microfabrication techniques, such as photolithographic techniques, wet chemical etching, micromachining, i.e., drilling, milling and the like, may be readily applied in the fabrication of microfluidic devices and substrates. Alternatively, polymeric substrate materials may be used to fabricate the devices of the present invention, including, e.g., polydimethylsiloxanes (PDMS), polymethylmethacrylate (PMMA), polyurethane, polyvinylchloride (PVC), polystyrene, polysulfone, polycarbonate and the like. In the case of such polymeric materials, injection molding or embossing methods may be used to form the substrates having the channel and reservoir geometries as described herein. In such cases, original molds may be fabricated using any of the above-described materials and methods. The channels and chambers of an exemplary device are typically fabricated into one surface of a planar substrate, as grooves, wells or depressions in that surface. A second planar substrate, typically prepared from the same or similar material, is overlaid and bound to the first, thereby defining and sealing the channels and/or chambers of the device. Together, the upper surface of the first substrate, and the lower mated surface of the upper substrate, define the interior portion of the device, i.e., defining the channels and chambers of the device. In some embodiments, the upper layer may be reversibly bound to the lower layer. In an embodiment, a substrate material is clarified polypropylene. Polypropylene is heat sealable, provides a natural vapor barrier, and being clarified has good optical properties. Other Olefins (Polypropylene or Polyethylene) could also be used. The laminated films (foils) can be heat sealable or adhesive adhered. In one embodiment, the foils provide vapor barrier properties to reduce or minimize evaporation of the liquid reagents, and to protect the dry reagents from stability damaging humidity and oxygen. In one embodiment, the foil comprises 0.001″ or thick pore free aluminum foil. This can be laminated with a heat or adhesive seal layer on one side, and a non-electrically conductive layer on the other on a side facing the PCB.

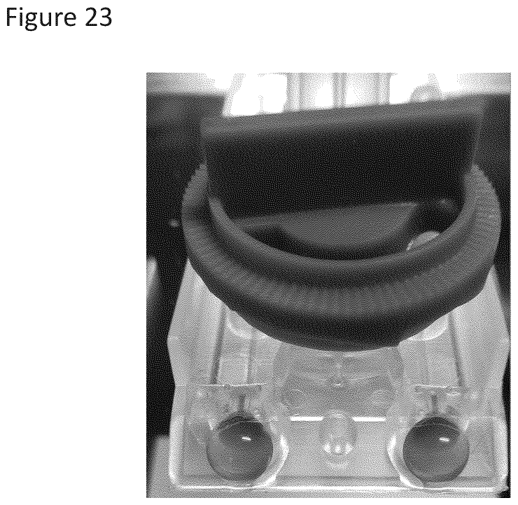

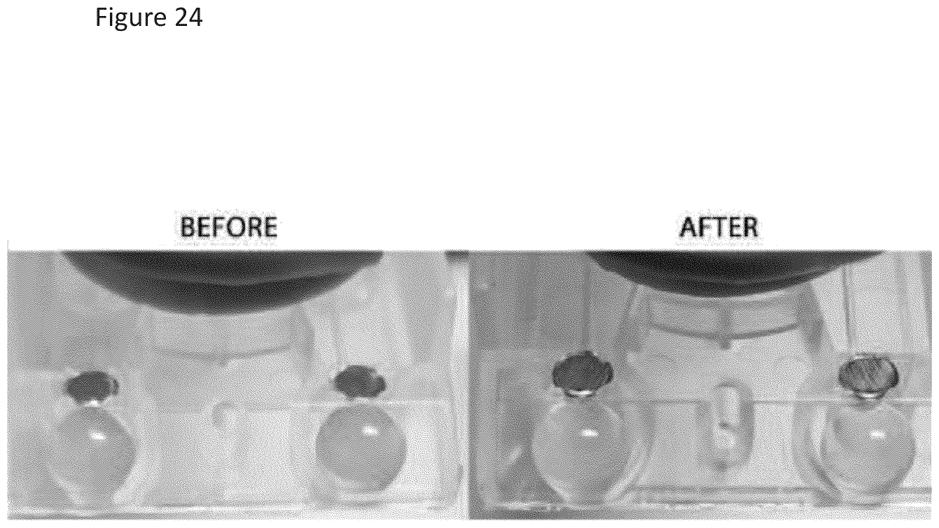

FIG. 23 shows filling of the reaction wells from the sample well using blue dye to track the movement of the liquid. FIG. 24 shows a LAMP reaction using colorimetric detection; cresol red dye changes color from pink to pale yellow as the reaction mixture pH drops due to liberation of pyrophosphate and hydrogen ions during DNA polymerization.

### Example 3: LAMP-LISA

To detect serum antibodies to an antigen (e.g. CoV2 Spike protein S1) from a saliva sample, the extraction mixture is augmented with reagents for a competitive binding immunoassay. A peptide derived from S1 is attached to agarose beads that are too large to enter the microfluidics pathway. A monoclonal antibody with moderate affinity for the peptide (Kd in the 0.1-10 μM range) is conjugated to a label comprising a DNA or RNA sequence suitable for LAMP amplification. If the patient sample contains antibodies with higher affinity for the peptide (tighter binding), then the labelled detector antibody will be displaced and then be able to enter the microfluidics pathway. The resulting positive signal in the reaction well (with suitable primers in the dried reagent bead) indicates presence of a host immune response to S1.

Using LAMP or RT-LAMP to amplify the DNA or RNA label provides a sensitive assay. Since the same LAMP reagents are used to amplify the label for a serological assay and the gene for a molecular assay, parallel detection of both protein and nucleic acid biomarkers of a pathogen can be accomplished. One useful application of such a dual detection assay is measuring escape rate of a virus under selection due to widespread vaccination or natural incidence. That is, escape from detection of the viral genome is qualitatively more difficult than escape from antibody binding to the viral antigen.

This LAMP-LISA assay format is quite different from a previously described “PCR-ELISA” in which the amplified PCR product incorporates a modified base (e.g. digoxigenin conjugated) which is then detected using an enzyme conjugated antibody to the modified base thereby increasing the sensitivity of the PCR assay to allow fewer amplification cycles and thus faster results {Sue M J, Yeap S K, Omar A R, Tan S W. Application of PCR-ELISA in molecular diagnosis. Biomed Res Int. 2014; 2014:653014}.

### Example 4: LAMP-LISA for Assay of Host Response

To detect a biomarker of the host immune response, an antibody against the biomarker is immobilized on the agarose beads in the extraction mixture. A DNA-labelled version of the biomarker protein is added to the extraction mixture, which is captured on the bead by the antibody. If the biomarker is present in the patient sample, it will displace the labelled tracer from the bead-bound antibody allowing it to enter the microfluidics pathway. The resulting positive signal in the reaction well indicates presence of the biomarker in the patient sample.

CoV2, influenza and RSV infections are each accompanied by host responses that contribute to the pathology. Variability in the host response may account for a substantial portion of the variability in disease severity. Measuring biomarkers of host response in conjunction with measuring viral presence allows improved assessment of prognosis. Precedent for measuring a key host response effector, interferon-gamma, in saliva has been reported in the context of biomarkers for host vs graft disease following organ transplant {Resende R G, Correia-Silva J D, Silva T A, Xavier S G, Bittencourt H, Gomez R S, Abreu M H. Saliva and blood interferon gamma levels and IFNG genotypes in acute graft-versus-host disease. Oral Dis. 2012 November; 18(8):816-22}. Similarly, a panel of inflammatory markers (including IL-6, IL-17a, and TNF-alpha) has been assayed in saliva to characterize patients with Sjögren's syndrome, an auto-immune condition {Hung Y H, Lee Y H, Chen P P, Lin Y Z, Lin C H, Yen J H. Role of Salivary Immune Parameters in Patients With Primary Sjögren's Syndrome. Ann Lab Med. 2019 January; 39(1):76-80}.

A biomarker of particular interest for concurrent assay of pathogen and host response is Class I interferons whose dysregulation has been implicated in the pathology of both RSV and CoV2 {Stephens L M, Varga S M. Function and Modulation of Type I Interferons during Respiratory Syncytial Virus Infection. Vaccines (Basel). 2020 Apr. 10; 8(2):177-193}; {Xia H, Shi P-Y. Antagonism of Type I Interferon by Severe Acute Respiratory Syndrome Coronavirus 2. Journal of Interferon & Cytokine Research 2020 December; 40(12):543-548}.

Although implementations have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A microfluidic device comprising:
a housing;
a substrate adapted to be disposed within the housing, the substrate comprising:
a sample port adapted to receive a sample and extract at least one analyte from the sample into a liquid assay sample,
a sample well coupled to the sample port,
a reaction well, a first microfluidic channel coupled at a proximal end to the sample well, and a second microfluidic channel coupled at a distal end to the reaction well, wherein a distal end of the first microfluidic channel and a proximal end of the second microfluidic channel are isolated from each other via a fluid channel seal,
a controller adapted to break the fluid channel seal and to meter the liquid assay sample from the sample well into the reaction well for an assay.

2. The microfluidic device of claim 1 wherein the substrate comprises a mounting substrate fixed within the housing.

3. The microfluidic device of claim 1 wherein the substrate is adapted for insertion into an assay instrument.

4. The microfluidic device of claim 1 wherein the microfluidic device comprises a disposable, single-use assay.

5. The microfluidic device of claim 1 wherein the substrate comprises a cartridge adapted to be removed from the housing.

6. The microfluidic device of claim 5 wherein the cartridge is adapted to be replaced by a second cartridge for a second assay.

7. The microfluidic device of claim 1 wherein the controller is adapted to puncture the fluid channel seal via a puncture piston.

8. The microfluidic device of claim 7 wherein the controller comprises a linear sliding controller comprising a puncture ramp surface adapted to press the puncture piston through the fluid channel seal to couple the distal end of the first microfluidic channel and the proximal end of the second microfluidic channel.

9. The microfluidic device of claim 7 wherein the controller comprises a knob comprising a puncture ramp surface, wherein the puncture ramp surface is adapted to press the puncture piston through the fluid channel seal to couple the distal end of the first microfluidic channel and the proximal end of the second microfluidic channel.

10. The microfluidic device of claim 8 or 9 wherein the knob or linear sliding controller comprises a syringe piston ramp, wherein the syringe piston ramp is adapted to withdraw a syringe piston to create negative pressure in the reaction well and draw a predetermined amount of the liquid assay sample into the reaction well via the second microfluidic channel.

11. The microfluidic device of claim 10 wherein the syringe piston is disposed within a syringe chamber coupled to a vent of the reaction well via a third microfluidic channel.

12. The microfluidic device of claim 1 wherein the controller is adapted to meter the liquid sample via a syringe piston.

13. The microfluidic device of claim 1 wherein the device comprises a second reaction well; a third microfluidic channel coupled at a proximal end to the sample well, and a fourth microfluidic channel coupled at a distal end to the second reaction well, wherein the controller is adapted to control a coupling of the first microfluidic channel to the second microfluidic channel and the third microfluidic channel to the fourth microfluidic channel.

14. The microfluidic device of claim 13, wherein the device comprises a second controller adapted to couple the sample well to a third reaction well and to a fourth reaction well via respective microfluidic channels.

15. The microfluidic device of claim 1 wherein the device comprises a second reaction well, a third microfluidic channel coupled at a proximal end to the sample well, and a fourth microfluidic channel coupled at a distal end to the second reaction well, wherein a distal end of the third microfluidic channel and a proximal end of the fourth microfluidic channel are isolated from each other via a second fluid channel seal, wherein the controller is further adapted to break the second fluid channel seal and to meter a second predetermined amount of the liquid sample from the sample well into the second reaction well for a second assay.

16. The microfluidic device of claim 15 wherein the device comprises a third reaction well, a fifth microfluidic channel coupled at a proximal end to the sample well, and a sixth microfluidic channel coupled at a distal end to the third reaction well, wherein a distal end of the fifth microfluidic channel and a proximal end of the sixth microfluidic channel are isolated from each other via a third fluid channel seal, wherein a second controller is further adapted to break the third fluid channel seal and to meter a third predetermined amount of the liquid sample from the sample well into the third reaction well for a third assay.

17. The microfluidic device of claim 16 wherein the device comprises a fourth reaction well, a seventh microfluidic channel coupled at a proximal end to the sample well, and an eighth microfluidic channel coupled at a distal end to the fourth reaction well, wherein a distal end of the seventh microfluidic channel and a proximal end of the eighth microfluidic channel are isolated from each other via a fourth fluid channel seal, wherein the second controller is further adapted to break the fourth fluid channel seal and to meter a fourth predetermined amount of the liquid sample from the sample well into the fourth reaction well for a fourth assay.

18. The microfluidic device of claim 17 wherein the assay comprises a SARS-CoV-2 assay, the second assay comprises an influenza A assay, the third assay comprises an influenza B assay, and the fourth assay comprises a control assay.

19. The microfluidic device of claim 1 wherein a reagent bead is disposed within the reaction well.

20. The microfluidic device of claim 19 wherein the reagent bead comprises a lyophilized bead comprising a concentrated assay reagent disposed on the lyophilized bead.

21. The microfluidic device of claim 19 wherein the reagent bead comprises analyte-specific DNA primers and analyte-independent reagents including enzymes for a LAMP assay.

22. The microfluidic device of claim 20 wherein the reagent bead further comprises reverse transcriptase for converting viral RNA into DNA for amplification.

23. The microfluidic device of claims 19 through 22 wherein a type of assay is determined by one or more components disposed on the reagent bead.

24. The microfluidic device of claim 23 wherein the type of assay is programmable by selecting between a plurality of different reagent beads.

25. The microfluidic device of claim 1 wherein the device comprises a printed circuit board disposed within the housing comprising at least one heating element disposed adjacent the reaction well.

26. The microfluidic device of claim 1 wherein the printed circuit board comprises a power switch adapted to activate the heating element under control of a second electronic controller.

27. The microfluidic device of claim 26 wherein the controller comprises a knob comprising a power switch ramp adapted to engage and activate the power switch as the knob is turned.

28. The microfluidic device of claim 26 wherein the housing comprises at least one air chamber adjacent the heating element.

29. The microfluidic device of claim 26 wherein the second electronic controller is adapted to activate an indicator when the assay is complete.

30. The microfluidic device of claim 29 wherein the second electronic controller is adapted to determine the assay is complete based upon a timer.

31. The microfluidic device of claim 1 wherein a seal is disposed covering the sample port.

32. The microfluidic device of claim 31 wherein the seal comprises a frangible and/or removeable seal.

33. The microfluidic device of claim 1 or claim 11 wherein the distal end of the second microfluidic channel comprises a progressively widening channel entering the reaction well.

34. The microfluidic device of claim 1 wherein the assay comprises at least one of the group:
influenza A, influenza B, and SARS-CoV-2, and a control assay.

35. A method of performing an assay comprising:
extracting an analyte from a sample received in a sample well via an extraction mixture into a liquid assay sample;
connecting a first microfluidic channel to a second microfluidic channel via a controller, the first microfluidic channel coupled to the sample well at a proximal end and the second microfluidic channel coupled to a reaction well at a distal end, wherein the controller breaks a fluid channel seal disposed between a distal end of the first microfluidic channel and a proximal end of the second microfluidic channel;
metering the liquid assay sample from the sample well into the reaction well via the controller; and
assaying the liquid assay sample in the reaction well.

36. The method of claim 35 wherein the controller punctures the fluid channel seal via a puncture piston.

37. The method of claim 36 wherein the controller comprises a linear sliding controller comprising a puncture ramp surface adapted to press the puncture piston through the fluid channel seal to couple the distal end of the first microfluidic channel and the proximal end of the second microfluidic channel.

38. The method of claim 36 wherein the controller comprises a knob comprising a puncture ramp surface, wherein the puncture ramp surface is adapted to press the puncture piston through the fluid channel seal to couple the distal end of the first microfluidic channel and the proximal end of the second microfluidic channel.

39. The method of claim 37 or 38 wherein the liner sliding controller or knob controller comprises a syringe piston ramp, wherein the syringe piston ramp is adapted to withdraw a syringe piston to create negative pressure in the reaction well and draw a predetermined amount of the liquid assay sample into the reaction well via the second microfluidic channel.

40. The method of claim 39 wherein the syringe piston is disposed within a syringe chamber coupled to a vent of the reaction well via a third microfluidic channel.

41. The method of claim 35 wherein the controller further couples a third microfluidic channel coupled at a proximal end to the sample well, and a fourth microfluidic channel coupled at a distal end to a second reaction well by breaking a second fluid channel seal disposed between a distal end of the third microfluidic channel and a proximal end of the fourth microfluidic channel.

42. The method of claim 41, wherein a second controller couples the sample well to a third reaction well and to a fourth reaction well via respective microfluidic channels.

43. The method of claim 42 wherein the assay comprises a SARS-CoV-2 assay, the second assay comprises an influenza A assay, the third assay comprises an influenza B assay, and the fourth assay comprises a control assay.

44. The method of claim 35 wherein a reagent bead is disposed within the reaction well.

45. The method of claim 44 wherein the reagent bead comprises a lyophilized bead comprising a concentrated assay reagent disposed on the lyophilized bead.

46. The method of claim 44 wherein the reagent bead comprises analyte-specific DNA primers and analyte-independent reagents including enzymes for a LAMP assay.

47. The method of claim 46 wherein the reagent bead further comprises reverse transcriptase for converting viral RNA into DNA for amplification.

48. The method of claims 44 through 47 wherein a type of assay is determined by one or more components disposed on the reagent bead.

49. The microfluidic device of claim 48 wherein the type of assay is programmable by selecting between a plurality of different reagent beads.

50. The method of claim 35 wherein the assay comprises a SARS-CoV-2 assay.

51. The method of claim 35 or claim 40 wherein the distal end of the second microfluidic channel comprises a progressively widening channel entering the reaction well.

52. The method of claim 35 wherein the assay comprises at least one of the group: influenza A, influenza B, and SARS-CoV-2, and a control assay.

53. The microfluidic device of claim 1 or the method of claim 35 wherein the assay comprises a colorimetric assay.

54. The microfluidic device or method of claim 53 wherein a lens is disposed adjacent the reaction well and is adapted for visual inspection of the colorimetric assay.

55. The microfluidic device or method of claim 53 wherein a detector is disposed adjacent the reaction well and is adapted to determine a result of the assay.

56. The microfluidic device or method of claim 55 wherein the detector comprises a photodiode.

57. The microfluidic device or method of claim 55 or 56 wherein a light emitting diode (LED) is disposed adjacent the reaction well and is adapted to illuminate the assay within the reaction well.

58. The microfluidic device of or method of claim 57 wherein the LED is disposed across the reaction well from the detector or photodiode.

59. The microfluidic device or method of claim 1 or the method of claim 35 wherein the assay comprises a fluorescent assay.

60. The microfluidic device or method of claim 59 wherein a detector is disposed adjacent the reaction well and is adapted to determine a result of the assay.

61. The microfluidic device or method of claim 60 wherein the detector comprises a photodiode.

62. The microfluidic device or method of claim 59 or 60 wherein a light emitting diode (LED) is disposed adjacent the reaction well and is adapted to illuminate the assay within the reaction well.

63. The microfluidic device or method of claim 62 wherein the detector or photodiode is disposed approximately 90 degrees from a path of illumination of the LED through the reaction well.

64. The microfluidic device of claim 1 or method of claim 35 wherein illuminating light is directed into the reaction well by at least one total internal reflectance element positioned within or adjacent to the reaction well.

65. The microfluidic device or method of claim 64 wherein the at least one total internal reflectance element is adapted to direct transmitted or emitted fluorescent light to a detector.

66. The microfluidic device or method of claim 65 wherein the detector comprises a photodiode.

67. The microfluidic device or method of claims 64 through 66 wherein one or more filters are disposed in or adjacent the reaction well to enhance signal to noise.
